(19) United States
(12) Patent Application Publication
(10) Pub. No.: US 2003/0028887 A1
(43) Pub. Date: Feb. 6, 2003

(54) Method to control the copying and/or broadcasting of audiovisual signals transmitted to within a home audiovisual network

(76) Inventors: Laurent Frouin, Rennes (FR); Arnaud Closset, Cesson-Sevigne (FR); Jean-Paul Accarie, Vern-Sur-Seiche (FR); Yacine El Kolli, Rennes (FR); Stephane Bizet, Rennes (FR)

Correspondence Address: FITZPATRICK CELLA HARPER & SCINTO, 30 ROCKEFELLER PLAZA, NEW YORK, NY, 10112, US

(21) Appl. No.: 10/186,611

(22) Filed: Jul. 2, 2002

(30) Foreign Application Priority Data
Jul. 2, 2001 (FR) 01 08770
Jul. 2, 2001 (FR) 01 08836
Jul. 2, 2001 (FR) 01 08834

(51) Int. Cl. H04N 7/18

(52) U.S. Cl. 725/78; 725/82; 725/74

(57) ABSTRACT

In a method for the transmission of audiovisual signals between at least one source node and at least one destination node of a home audiovisual network, said source node or nodes insert a piece of information, into said audiovisual signals, to control the copying and/or broadcasting of said audiovisual signals by said destination node or nodes.

### BACKGROUND OF THE INVENTION

The field of the invention is that of home audiovisual networks of the type used to interconnect a plurality of audio and/or video analog and/or digital type terminals (also called devices) so that they exchange audiovisual signals.

These terminals belong, for example, to the following list of equipments (which is not exhaustive): television receivers (using satellite, RF channels, cable, xDSL and other means), television sets, video tape recorders, scanners, digital video cameras, digital cameras, DVD readers, computers, personal digital assistants (PDAs), printers, etc.

The home audiovisual network is for example of the high bit rate switched type comprising a small number of nodes, used especially for the real-time exchange of moving pictures for distribution within a dwelling.

A home audiovisual network according to the invention comprises a plurality of nodes connected by a plurality of physical communication links. These links are for example of the type used for two-way data transfers according to the IEEE 1355 standard.

Audio and/or video terminals communicate with one another through the nodes to which they are connected. The nodes that form the skeleton of the network comprise especially:

first interface means enabling the connection, through one or more links (for example according to the IEEE 1355 standard), of one or more other nodes;

second interface means used for the connection of one or more analog terminals (namely terminals capable of receiving audiovisual signals in analog form);

third interface means used for the connection (for example through a digital bus according to the IEEE 1394 standard) of one or more digital terminals (namely terminals capable of receiving audiovisual signals in digital form).

A home audiovisual network of this kind works as follows: a connection is set up, through a plurality of nodes, between a first terminal (or listener) that seeks to receive audiovisual signals and a second terminal (or talker) that can give it these signals.

Some elements of the terminology used hereinafter in the description shall now be specified.

The first terminal mentioned here above is called a destination terminal and the node to which it is connected is called a destination node.

In the case of the second terminal mentioned here above, two cases may be distinguished.

In a first case, the second terminal is integrated into a node called a “source node”. Thus, it is assumed that the source node comprises means for the reception and/or reading of source signals (originating outside the network) and means for the transmission of these source signals, in the form of the above-mentioned audiovisual signals, to the destination node. In other words, the source node receives and/or reads source signals and introduces them into the home audiovisual network in the form of audiovisual signals. In this first case, the (source) node and the second terminal are the same.

The present invention can be applied preferably to the case where the source node includes a television receiver (for example in France a “TPS” (registered mark) receiver or “Canal Satellite” (registered mark) receiver). In this case, the source node is also called a “Tuner Unit”. It enables the direct introduction into the network, in digital form (generally encoded in the MPEG2 format) of source signals given by an operator and containing television programs.

In a second case, the second terminal called an “input terminal” is connected to a node called an “input node”. Unlike the first case, the (input) node and the second terminal are not the same. The input node does not have means for the reception and/or reading of source signals (originating outside the network). The input node receives audiovisual signals coming from the input terminal and introduces them into the home audiovisual network.

The term input terminal is understood to mean for example a camcorder, a digital camera, a digital output DVD reader or any analog device seen through an analog/digital converter.

Technical Problem and Prior Art of CRF-464 (7093)

More specifically, the invention relates to the control of the copying and/or the broadcasting of audiovisual signals introduced by source nodes into a home audiovisual network.

It will be understood for example that an operator providing a source node with source signals containing television programs wishes that some (or even all) of these programs should be incapable of being illegally copied by a user of the network who has a terminal, within this network, fitted out with means for recording on a data medium.

In a first known mechanism for the protection of audiovisual signals when they are digital type signals, a DTCP format encoding is applied to these signals (see detailed explanation here below with reference to the figures). This first known protection mechanism assumes the presence of DTCP format encoding means at one end and corresponding decoding means at the other end. Now DTCP format encoding or decoding means are very costly at present. It is therefore not possible to consider equipping each node of the network with such means.

In a second known protection means, audiovisual signals, when they are analog type signals, are partially scrambled in order to prevent them from being copied. An anti-copy scrambling of this kind is done for example according to the “Macrovision” (registered mark) standard (see detailed explanation here below with reference to the figures). This second known protection mechanism cannot, at present, be implemented and activated systematically in all the destination nodes of the home audiovisual network to which analog terminals are connected. Indeed, the user should be left with the possibility of copying certain audiovisual signals which are not subjected to any special protection. For example, he is allowed to make a video tape recording of a program broadcast on a public television station.

It can be seen therefore that the two known protection mechanisms described here above (DCTP and “Macrovision”) cannot be used alone or in combination to provide optimum protection to audiovisual signals at an acceptable cost.

Technical Problem and Prior Art of CRF-465 (7094)

Besides, at present, the digital television receivers (tuner units) are designed to deliver a single channel (a single television station) to a single terminal. They therefore receive a source signal by cable or satellite combining several tens of channels and carry out the processing needed to extract the channel that the user wishes to watch.

These solutions are satisfactory for the user if he has a single television set. However, it is not satisfactory if he has a home network as described further above. Indeed, several users may wish to see different programs and different television sets (or recording means) or again see the same program on different television sets.

From the operator s viewpoint, however, this possibility is not desirable since he cannot control it. The programs that he broadcasts must be paid for, by subscription for example, and such an approach would entail an unacceptable loss of earnings.

Similarly, the fact of making it possible to give multiple access to channels without control raises issues of intellectual property over the works that are broadcast and, as the case may be, recorded.

For these different reasons, each digital receiver can deliver only one channel. The only solution for the user therefore is to have several digital receivers to be able to use several channels on his home network.

This solution is not practical (it means connections have to be made, and it entails congestions and also a large number of remote controls to be used, etc.) and it is costly (it necessitates several receivers comprising the same elements). It is furthermore fixed: the only way for the user to modify his subscription is return the receiver and get a new receiver.

There is therefore a major need that has not yet been met for a simple and open-ended solution that meets both the expectations of the users and the requirements of the operators.

It must be noted that the formulation of this need per se is not obvious. Indeed, those skilled in the art are convinced that there is no reliable alternative to the present technique in which a channel is physically associated with a receiver.

Technical Problem and Prior Art of CRF-466 (7095)

The inventors of the present invention have also identified a novel problem in the implementation of these home networks: they are essentially limited to a site (conventionally a house or an apartment), and those skilled in the art are convinced that the situation cannot be any different (the goal being always that of controlling the broadcasting and copying of the signals transmitted).

The invention therefore also concerns the novel problem of the remote use of means for the reception of source signals belonging to a home audiovisual network.

Indeed, it will be understood that it may be particularly advantageous for a user of a home audiovisual network to be able, in a remote site, to benefit from the resources offered by such a network. Thus, a user may wish for example, in his vacation home, to benefit from the satellite television reception means that he has available in his primary home.

Now, to date, there is no solution enabling this kind of remote use of the functionalities offered by a home audiovisual network and especially by a source node of such a network. The exploitation of the resources of a home audiovisual network is therefore restricted to the geographical perimeter of the network.

If the user wishes to receive satellite television in his vacation home, he must therefore either fully equip this home, and therefore have two complete and costly sets of equipment or carry his receiver from one site to the other (especially for the setting of the satellite aerial), thus depriving anybody who remains in his primary home of access to the satellite.

Besides, the idea of providing means of broadcasting towards remote sites is unthinkable to those skilled in the art as it would then be possible to make illegal copies of the signals, broadcast them or copy them without paying the corresponding fees.

### SUMMARY OF THE INVENTION

Goals of CRF-464 (7093)

It is a goal of the invention to overcome these various drawbacks of the prior art.

More specifically, one of the goals of the present invention is to provide a method to control the copying of audiovisual signals introduced by the source nodes into a home audiovisual network.

It is also a goal of the invention to provide a method of this kind that does not require the implementation of a decoding module in the DTCP format in each node of the network.

Another goal of the invention is to provide a method of this kind that can also be used to control the broadcasting of the audiovisual signals introduced by the source nodes into the home audiovisual network.

An additional goal of the invention is to provide a method of this kind that can benefit from the advantages related to the anti-copy scrambling (for example according to the “Macrovision” standard), namely providing authorization for viewing (for example on a television set) while at the same time prohibiting copying (for example on a video tape recorder).

Yet another goal of the invention is to provide a method of this kind that can be used to make the protection of certain audiovisual signals coexist with the absence of protection of certain other audiovisual signals.

Goals of CRF-465 (7094)

Another goal of the invention is to provide a technique by which it is possible to obtain optimized use of a television digital receiver or tuner unit in compliance with subscriptions or with authorization delivered by one or more operators.

Thus, a goal of the invention is to provide a technique of this kind by which several users of one and the same home network can receive distinct channels on distinct terminals, these distinct channels being delivered by one and the same digital receiver.

It is also a goal of the invention to provide a technique of this kind that enables operators to provide a variety of open-ended services in terms of subscription, promotion, selective access to channels and distinct programs.

Yet another goal is to provide a technique of this kind making it possible also to control access to certain channels or certain programs within the home network.

Another goal of the invention is to provide a technique of this kind that needs hardware means that are limited and therefore less costly than those of an installation requiring several digital receivers.

Goals of CRF-466 (7095)

Yet another goal of the invention is to provide a technique that enables a use, in a remote site, of means for the reception of source signals belonging to a home audiovisual network.

Another goal of the invention is to implement a technique of this kind that enables the broadcasting of audiovisual signals in a home audiovisual network that does not comprise means for the reception of source signals.

An additional goal of the invention is to provide a technique of this kind by which it is possible to guarantee the protection of the audiovisual signals transmitted to a remote site.

Yet another goal of the invention is to make it possible for any user to use any means and any function to which he has access wherever he may be (for example in his primary home or in his vacation home).

It is also a goal of the invention to provide a technique of this kind that is simple and costs little to implement.

Yet another goal of the invention is to enable a geographical sharing, between at least two remote sites, of the rights of access to source signals allocated by an operator.

Features and Corresponding Comments of Transmission Method Claims from CRF-464 (7093)

Some of these goals, as well as others that shall appear hereinafter, are achieved according to the invention by means of a method for the transmission of audiovisual signals between at least one source node and at least one destination node of a home audiovisual network. According to the invention, said source node or nodes insert a piece of information, into said audiovisual signals, to control the copying and/or broadcasting of said audiovisual signals by said destination node or nodes.

The general principle of the invention consists therefore in carrying out an additional operation in the source node (the association with audiovisual signals of a piece of control information) so that the destination node knows that it must carry out an operation related to the copying and/or broadcasting of audiovisual signals that it receives from the source node.

In a particular embodiment of the invention, said home audiovisual network is a switched type network.

Preferably, said piece of control information comprises a first information element specifying whether a destination node permits or does not permit at least one destination terminal, connected to said destination node, to copy said audiovisual signal on a data carrier.

In other word, the source node decides on the processing that the destination node must apply to an audiovisual signal that it sends to it. On this processing depends the fact that a destination terminal connected to this destination node can copy or not copy the above-mentioned audiovisual signal.

Advantageously, said first information element is encoded on one bit.

Advantageously, said first information element, depending on its value, activates or deactivates anti-copy means contained in the corresponding destination node, acting on said audiovisual signal so as to enable it to be viewed (for example on a television set) but not recorded (for example on a video tape recorder).

In a particular embodiment of the invention, said anti-copy means introduce scrambling according to the “Macrovision” standard.

Preferably, said control information comprises a second information element specifying whether the corresponding audiovisual signal is intended for a particular destination terminal, connected to a destination node, and/or for a particular user or whether it can be transmitted to any destination terminal connected to a destination node.

As in the case of the first information element discussed here above, the source node decides on the processing that the destination node must apply to an audiovisual signal that it sends to it. On this processing depends the fact that a destination terminal connected to this destination node will or will not be the only terminal that can receive the above-mentioned audiovisual signal.

Advantageously, said second information element is encoded on one bit.

Preferably, when said second information element specifies that the audiovisual signal is intended for a particular destination terminal connected to a destination node and/or a particular user, the destination node implements a corresponding control mechanism.

In other words, the destination node ascertains that the particular destination terminal and/or the particular user is (are) effectively authorized to receive the audiovisual signal coming from the source node.

Preferably, said control mechanism comprises a step for the detection of a local key known to said destination node and/or introduced by said user. The processing of the local key may be done by the destination node (which for example compares this local key with a reference key stored in its protected memory) or by another piece of equipment of the network (for example the source node).

In a preferred embodiment of the invention, said control information includes said first information element and said second information element.

In other words, the above-mentioned first and second embodiments are combined, providing for the association of different levels of protection for the destination terminals.

Preferably, the information on the audiovisual signals intended for a particular destination terminal and/or a particular user are not accessible to the other nodes of the network or to the terminals connected to these other nodes.

The term information pertaining to an audiovisual signal is understood for example to mean information by which a user can known which stations and/or which television broadcasts are being watched by other users of the network. In this way, if a given destination terminal is the only one that can receive an audiovisual signal, the other destination terminals are not given the possibility of “spying” on what is being received by the given destination terminal.

In a preferred embodiment of the invention, said audiovisual signals, called first audiovisual signals, transmitted by said source node to a destination node are in digital form according to a first encoding format. Furthermore, said first audiovisual signals undergo a decoding, in said destination node, corresponding to said first encoding format and are then transmitted to a destination terminal connected to said destination node: they are transmitted either in said decoded digital form if said destination terminal is digital or, after digital/analog conversion, in analog form if said destination terminal is an analog device. Finally, said source node assigns said control information an inactive value when said destination terminal is digital.

In other words, there is no control on the copying or the broadcasting of the audiovisual signals that the source node sends to digital terminals.

Advantageously, the method according to the invention comprises a preliminary step of connection between said destination node and the source node during which said destination node gives said source node a piece of information on nature, namely the analog or digital nature, of said destination terminal.

It is this information (on the analog or digital nature) that enables the source node to take a decision on the value to be given to the control information.

Preferably, at least certain of said first audiovisual signals furthermore undergo a DTCP type encoding in the source node, corresponding decoding means being provided in the destination terminal, connected to said destination node.

Thus, the protection on the audiovisual signals constituted by the application to these signals of a DTCP type encoding in the source node justifies the fact that neither their copying nor their broadcasting is controlled.

In a preferred embodiment of the invention, said audiovisual signals, called first audiovisual signals, transmitted by said source node to a destination node are in digital form according to a first encoding format. Furthermore, second audiovisual signals can be transmitted from an input terminal to an input node (a notion distinct from that of the source node) to which said input terminal is connected in digital form according to a second encoding format, distinct from said first encoding format. Finally, when a destination node receives said second audiovisual signals from said input node, said destination node does not take account of said control information.

In other words, there is no control on the copying or broadcasting of audiovisual signals that the source node sends to digital terminals. This can be explained by the fact that only the source nodes are capable of deciding on a value to be given to a piece of control information to be associated with an audiovisual signal. With respect to the preferred embodiment described here below, this means that the field containing the control information is informed by the source nodes but not by the input nodes. It is therefore necessary not to take account of the contents of this field when it is associated with a signal coming from the input node.

Advantageously, the first and second encoding formats are MPEG (and preferably MPEG2) and DV formats respectively.

Preferably, when said destination node has to take account of said control information and when this information prohibits copying, said destination node systematically closes the accesses to the digital output(s) that it possesses.

In this way, it is ensured that the protected audiovisual signals (namely signals whose copying is prohibited) coming from the source node are not transmitted by the destination node to digital terminals connected to this source node. This is valuable, especially when the following two conditions are verified:

the above-mentioned rule, according to which the control information takes an inactive value when the destination terminal is digital, is not applied, and

the above-mentioned protection mechanism in which a DTCP type encoding is applied is not implemented.

In an advantageous embodiment of the invention, said audiovisual signals are conveyed between a source node and a destination node in successive packets, each comprising a header and a data field.

Advantageously, said control information is transmitted in a particular field, designed for this purpose, of said header, in at least certain of said packets, and preferably in all the packets.

Features and Corresponding Comments of Added Method Claims from CRF-465 (7094)

In a preferred embodiment of the invention, said method implements a token-based mechanism for the transmission of the audiovisual signals. Prior to said transmission of said audiovisual signal, said method comprises a step for assigning an available conditional access token to a connection enabling said transmission between the source node and the destination node, said conditional access token authorizing: the transmission of said audiovisual signal to the destination node, and the processing of said audiovisual signal by the destination node only if the destination node fulfills a predetermined condition. Said piece of information, inserted in said audiovisual signal by the source node or nodes to control the copying and/or broadcasting, specifies said determined condition.

Thus, by means of a single source node (digital receiver), it is possible to broadcast several distinct channels to several terminals of a home network while at the same time preserving precise control, from an operator's point of view, over the number and/or type of channels delivered, as a function of authorization or subscription, concretely represented in the source nodes by tokens.

This also makes it possible to introduce great flexibility into the management of the subscriptions or instances of authorization simply by allocating or withdrawing tokens without any need to take action on the hardware or to add digital receivers.

As shall be seen hereinafter, the tokens may correspond to any channel whatsoever or to a particular channel, or again they may be associated with particular conditions.

Advantageously, said tokens are managed by said at least one source node.

Furthermore, it is possible advantageously to distinguish two types of tokens (which may or may not cohabit as a function of need: generic tokens and dedicated tokens).

Thus preferably, at least certain of said tokens are generic tokens enabling access to any one of the channels of the set of channels received by said source node.

Similarly, advantageously, at least certain of said tokens are dedicated tokens enabling access to predetermined audiovisual signals. These predetermined audiovisual signals may belong especially to the group comprising:

audiovisual signals relating to a predetermined channel of a set of channels received by said source node;

audiovisual signals relating to a predetermined program of a channel among a set of channels received by said source node;

audiovisual signals relating to a predetermined family of programs.

Furthermore, according to an advantageous aspect of the invention, at least certain of said tokens are dated, timed and/or have a predetermined lifetime.

Features and Corresponding Comments of Transmission Method Claims from CRF-466 (7095)

In a preferred embodiment of the invention, said at least one source node is comprised in a primary home audiovisual network, and comprises reception means for the reception of a source signal and transmission means for the transmission of said source signal in the form of an audiovisual signal in which is inserted said piece of information to control the copying and/or broadcasting. Said at least one destination node is comprised in a secondary home audiovisual network in a remote site, and does not comprise reception means for the reception of said source signal. Said primary and secondary networks are each equipped with a gateway enabling their transparent interconnection, through a communications network, so that said source signal received by said source node of said primary network can be transmitted in the form of said audiovisual signal, to said destination node of the secondary network.

Thus, the invention relies on an absolutely novel and inventive approach to the use of the means for the reception of source signals belonging to a home audiovisual network. Indeed, the invention advantageously enables the use of such a remote means and more specifically within a secondary home audiovisual network. Furthermore, a remote use of this kind can be done transparently for the user of the secondary network who may thus for example display, on a terminal of the secondary network, source signals received by a satellite television receiver of the primary network.

It will be noted of course that the invention also enables the interconnection of two home audiovisual networks each comprising at least one source node so that a destination node of the secondary network can preferably access the source signals received by the source node of the primary network (for example in France a TPS (registered mark)) satellite television receiver rather than those of the source node of the secondary network (for example in France Canal Satellite (registered mark) satellite television receiver).

The primary network corresponds for example to a main residence and a secondary network to a secondary residence or to any place fitted out with a gateway. In a particular embodiment of the invention, the secondary network may be reduced to a portable terminal (for example a computer) by which the user can access his subscriptions and his programs wherever he may be in the world.

Preferably, said primary and secondary networks are switched type networks.

Advantageously, said primary and secondary networks implement one and the same proprietary transmission protocol.

This method ensures firstly the security of the data travelling in transit between the gateways of the primary and secondary networks and secondly the transparency, for a destination node of the secondary network, of its connection to a source node of the primary network.

According to an advantageous characteristic of the invention, said interconnection between said gateways includes a mutual identification step.

Such a characteristic guarantees the security of the data travelling in transit between the two gateways of primary and second networks. Indeed, only the gateway of a secondary network authenticated by an instant of the primary network (for example the gateway of the primary network) is thus entitled to receive network signals coming from the primary network.

Preferably, a method of this kind comprises an initialization step and a step for transmitting an audiovisual signal.

Prior to the transmission by the source node of the audiovisual signal to a destination node that has made a request for it, it is also possible to envisage a case where the source node verifies the membership of the destination node in one or the other of the primary and secondary networks, so as to launch a phase of activation of the gateways if the destination node belongs to the secondary network.

According to an advantageous technique of the invention, a connection is set up for each of said steps and interrupted at the end of each of said steps.

Preferably, said initialization step includes a sub-step for the transmission of information on the availability of said primary network, comprising:

information on the source node or nodes (whether active or not) of these primary networks;

information on the input node or nodes (whether active or not) of the primary network;

information on the input terminal or terminals (whether active or not) of the primary network;

information on the destination node or nodes (whether active or not) of the primary network;

information on the destination terminal or terminals (whether active or not) of the primary network.

Thus, a first temporary connection is set up between the gateways of the primary and secondary networks during which control data and configuration data are exchanged, enabling especially a user of the secondary network to know the source nodes of the primary network to which he can get connected.

According to an advantageous technique, said communications network belongs to the group comprising:

Internet type networks;

telephony type networks;

radiotelephony type networks;

television broadcast networks.

It is thus possible to envisage a case where the telephone line is reserved exclusively for the transmission of audiovisual signals between the two gateways of primary and secondary home audiovisual networks. The communications network can of course also be of any other type enabling the interconnection, through two primary and secondary gateways, of two home audiovisual networks according to the invention.

According to an advantageous characteristic of the invention, said gateways comprise means of compression/decompression and/or encryption/decryption.

The gateway of the primary network can thus especially encrypt the data that it wishes to send to the gateway of the secondary network, for example in such a way as to increase their security during this transmission by the communications network. The gateway of the secondary network, upon reception of the encrypted data, can then carry out corresponding decryptions and then transmit the decrypted data to the destination node of the secondary network which has asked for it.

The gateway of the primary network can also compress the audiovisual signals prior to their transfer to the gateway of the secondary network so as to increase the bit rate of such a transmission.

Features and Corresponding Comments of Device and Source Node Claims from CRF-464 (7093) and CRF-465 (7094)

The invention also relates to a (first) device included in a home audiovisual network interconnecting at least one source node and at least one destination node, said device comprising means for the insertion, into an audiovisual signal to be sent from a source node to a source destination, of a piece of information to control the copying and/or broadcasting of said audiovisual signal by said destination node.

Preferably, said (first) device comprises means for the management of a set of tokens, an audiovisual signal being incapable of being transmitted from a source node to a destination node unless a corresponding token is available.

Preferably, said (first) device is included in a source node.

Features and Corresponding Comments of Device and Destination Node Claims from CRF-464 (7093)

The invention also relates to a (second) device included in a home audiovisual network interconnecting at least one source node and at least one destination node, said device comprising means for the analysis of a piece of information to control the copying and/or broadcasting of an audiovisual signal by a destination terminal, said control information being inserted into an audiovisual signal sent by a source node.

Advantageously, said (second) device comprises anti-copy means acting on said audiovisual signal so as to enable its viewing but not its recording, said anti-copy means being controlled by said analysis means.

Preferably, said (second) device is included in a destination node.

Features and Corresponding Comments of Control Method Claims from CRF-464 (7093)

The invention also relates to a method for the control, by a remote operator, of an authorization of copying and/or broadcasting, in a home audiovisual network, of audiovisual signals given by said remote operator. According to the present invention, said operator transmits, to a source node of said audiovisual network, designed to transmit said audiovisual signals to at least one destination node, a piece of information to control the copying and/or the broadcasting of said audiovisual signals by said destination node or nodes, said control information being designed to be inserted by said source node into said audiovisual signals.

Features and Corresponding Comments of Control Method Claims from CRF-465 (7094)

The invention also relates to a method of control by a remote operator of an authorization of transmission of an audiovisual signal, given by said remote operator of a source node to a destination node of a home audiovisual network. According to the invention, said remote operator transmits information on a token-based mechanism to said source node as a function of requests from the user and/or promotional operations, said audiovisual signal being incapable of being transmitted to said destination node unless a corresponding token is available.

The technique of the invention enables the operator to achieve very flexible and open-ended management of the authorization that he delivers to subscribers to his television broadcasting server. For example, for the duration of sports event, a television operator may sell additional tokens so as to temporarily extend access by a user to his sports channels.

Features and Corresponding Comments of Gateway Claims from CRF-466 (7095)

The invention also relates to a gateway of a primary home audiovisual network comprising at least one source node and comprising means of interconnection to a gateway of a secondary home audiovisual network comprising at least one destination node so that a source signal received by a source node of said primary network can be transmitted in the form of an audiovisual signal, to a destination node of the secondary network, without there being means included in this secondary network for the reception of said source signal.

The invention also relates to a gateway of a secondary home audiovisual network comprising at least one destination node comprising means of interconnection to a gateway of a primary home audiovisual network comprising at least one source node so that a source signal received by a source node of said primary network can be transmitted, in the form of an audiovisual signal, to a destination node of the secondary network, without there being means included in this secondary network for the reception of said source signal.

Features and Corresponding Comments of Allocation Method Claim from CRF-466 (7095)

The invention also relates to a method for the allocation by an operator of transmission resources on a communication network.

According to the invention, the conditions of allocation of said resources for a link between a gateway of a primary home audiovisual network and a gateway of a secondary home audiovisual network depend on access rights pertaining to a source node of said primary network allocated by a third-party operator.

Thus, for example, a telephony operator and a television operator may come together to set up preferential conditions of use of a telephone line between two gateways of a primary home audiovisual network and a secondary home audiovisual network enabling the implementation of the invention.

Features and Corresponding Comments of Computer Program Claims from CRF-464 (7093)

The invention also relates to a computer program comprising instruction sequences adapted to the implementation of a method of the kind mentioned here above, when said program is executed on a computer.

The invention also relates to a computer program product adapted to the transmission of audiovisual signals between at least one source node and at least one destination node of a home audiovisual network, said computer program product comprising program code instructions recorded in a medium that can be used in a computer, comprising programming means readable by computer to carry out a phase for the insertion inside said audiovisual signals, by said source node or nodes, of a piece of information to control the copying and/or the broadcasting of said audiovisual signals by said destination node or nodes.

Features and Corresponding Comments of Control Method Claims from CRF-464 (7093)

The invention also relates to a method for controlling the transfer of multimedia data within a multimedia network comprising at least a source node and a destination node, at least the destination node being connected to different types of terminals, information regarding the access and/or the copy of said multimedia data being included into said multimedia data. The processing of the information regarding the access and/or the copy of the multimedia data is made according to the type of the destination terminal.

Preferably, the type of the destination terminal is analog or digital terminal.

### BRIEF DESCRIPTION OF THE DRAWINGS

Other features and advantages of the invention shall appear from the following description of a preferred embodiment of the invention, given by way of a simple, illustrative and non-restrictive example, and from the appended drawings, of which:

FIGS. 1 to 12 of CRF-464 (7093)

FIG. 1 is a block diagram of a home audiovisual network in which the present invention is implemented;

FIG. 2 illustrates the structure of a source node of the home audiovisual network according to FIG. 1;

FIG. 3 illustrates the structure of a destination node of the home audiovisual network of FIG. 1;

FIG. 4 presents a flow chart describing an algorithm for processing a packet, according to the invention, in a destination node of the home audiovisual network of FIG. 1;

FIG. 5 illustrates the structure of a packet according to the invention conveying an audiovisual signal between a source node and the destination node of the home audiovisual network of FIG. 1;

FIG. 6 illustrates a remote control pack used by a user to communicate with a destination node of the home audiovisual network of FIG. 1;

FIGS. 7 to 9 are different flow charts describing the algorithms of operation of the remote control pack of FIG. 6, enabling especially a user to formulate a request for connection with a destination terminal (“listener”) and a source node or an input terminal (“talker”);

FIG. 10 is a flow chart describing an algorithm for the processing of a packet, according to the invention, in a source node of the home audiovisual network of FIG. 1;

FIG. 11 is a flow chart describing an algorithm for the creation of a sub-list of active destination terminals (“listeners”) that can be viewed by a user;

FIG. 12 is a flow chart describing an algorithm for the creation of a sub-list of active transmitter devices (“talkers”) that can be viewed by a user;

FIG. 13 of CRF-465 (7094)

FIG. 13 is a flow chart describing an algorithm for the implementation of the token-based mechanism according to the invention in a source node of the home audiovisual network of FIG. 1;

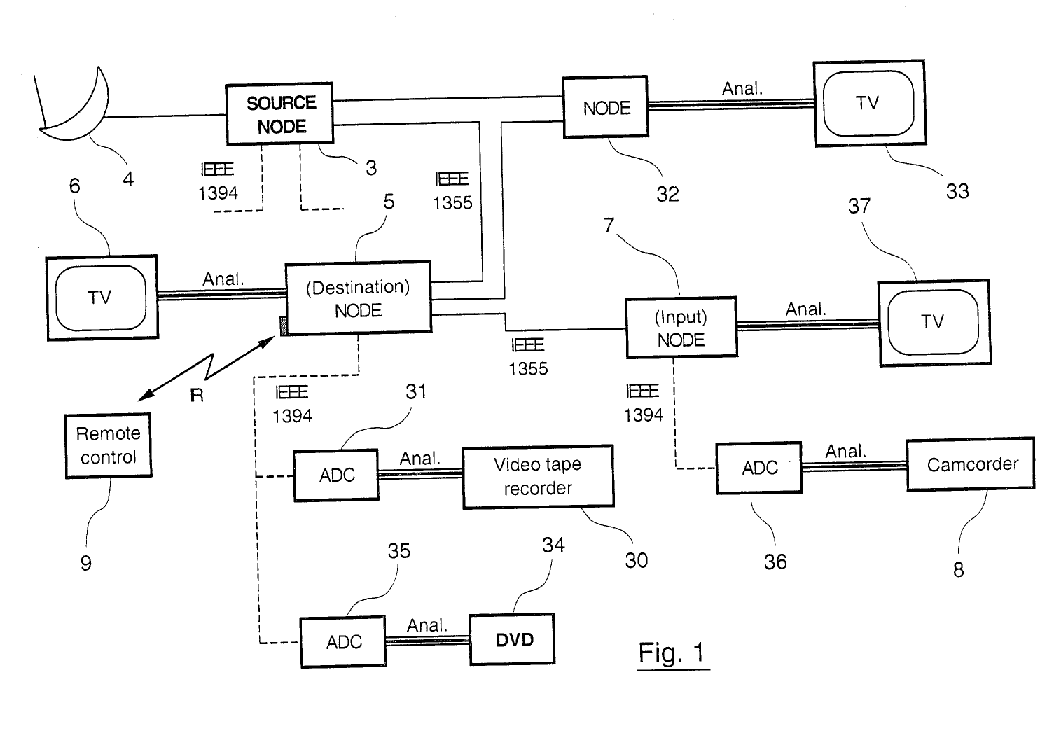

FIGS. 1 and 10 to 13 of CRF-464 (7093), renumbered 14 to 18

FIG. 14 is a block diagram of a primary home audiovisual network connected by a set of two gateways to a secondary home audiovisual network according to the invention;

FIG. 15 shows an exemplary structure of a gateway of a primary or secondary home audiovisual network according to the invention;

FIGS. 16 to 18 are different flow charts describing algorithms of operation of the gateways of FIG. 15 when a user of the secondary home audiovisual network requests that a temporary or permanent connection be set up with the primary home audiovisual network.

### MORE DETAILED DESCRIPTION

The present invention therefore relates to a method to control the copying and/or the broadcasting of audiovisual signals introduced by source nodes in a home audiovisual network.

Optionally, a token mechanism is implemented and used to manage the broadcasting of several distinct channels to several terminals of a home network as a function of instances of authorization or subscriptions, concretely represented in the source node by tokens.

It must be noted that this token mechanism can be implemented in combination or independently from the aforesaid method to control the copying and/or the broadcasting of audiovisual signals.

Also optionally, the invention relies on the interconnection of two primary and secondary home audiovisual networks through two gateways so as to enable the remote use, by a destination node of the secondary network, of a source signal received by the source node of the primary network.

Again, it must be noted that this interconnection of primary and secondary home audiovisual networks through gateways can be implemented in combination or independently from the aforesaid method to control the copying and/or the broadcasting of audiovisual signals.

Referring now to the block diagram of FIG. 1, we shall describe an exemplary home audiovisual network in which the present invention can be implemented.

It will be recalled that the home audiovisual network is of the type comprising a plurality of nodes enabling the interconnection of a plurality of audiovisual terminals.

Each node is equipped with:

a first IEEE 1355 type interface (input/output) interface used to connect this node to other nodes;

a second IEEE 1394 type (input/output) interface used to connect this node to a digital bus to which it is possible to connect digital terminals or, through analog/digital converters, analog terminals;

a third analog type (output only) interface used to connect this node to an analog terminal;

a fourth infrared type (input) interface used to send commands from a remote control pack 9 to the node, in the context of a man/machine interface between a user and the node.

In the example of FIG. 1, the home audiovisual network comprises:

a source node 3 including a satellite television receiver whose antenna is referenced 4. This source node 3 is connected to the nodes referenced 5 and 32, through IEEE 1355 type links. Purely with a view to simplification, no analog terminal is connected to its analog interface and no IEEE 1394 type bus is connected to its corresponding interface;

a node referenced 5 connected to the nodes referenced 3, 7 and 32 through IEEE 1355 type links. A television set 6 is connected to its analog interface. An IEEE 1394 type bus is connected to its corresponding interface and two terminals are connected to this bus, namely a video tape recorder 30 and a DVD reader 34, each through an analog/digital converter 31 and 35;

a node referenced 32 connected to the nodes referenced 3 and 5 through IEEE 1355 type links. A television set 33 is connected to its analog interface;

a node referenced 7, connected to the node referenced 5, through an IEEE 1355 type link. A television set 37 is connected to its analog interface. An IEEE 1394 type bus is connected to its corresponding interface and a terminal, namely a camcorder (registered mark) 8, is connected to this bus through an analog/digital converter 36. It is clear that, if the camcorder 8 has a digital output, it can be connected directly to the IEEE 1394 type bus.

By way of an illustrative example, the following two cases are considered hereinafter in the description:

first case: the user wishes to receive a satellite television program on the television set 6 connected to the node 5, this satellite television program being received by the source node 3 (“talker”). In this first case, the television set 6 is a destination terminal (“listener”) and the node referenced 5 is a destination node);

second case: the user wishes to receive, on the television set 6, connected to the node 5, audiovisual signals generated by the camcorder 8 connected to the node referenced 7. Just as in the first case, the television set 6 is a destination terminal (“listener”) and the node referenced 5 is a destination node.

Furthermore, the camcorder 8 is an input terminal (“talker”) and the node referenced 7 is an input node.

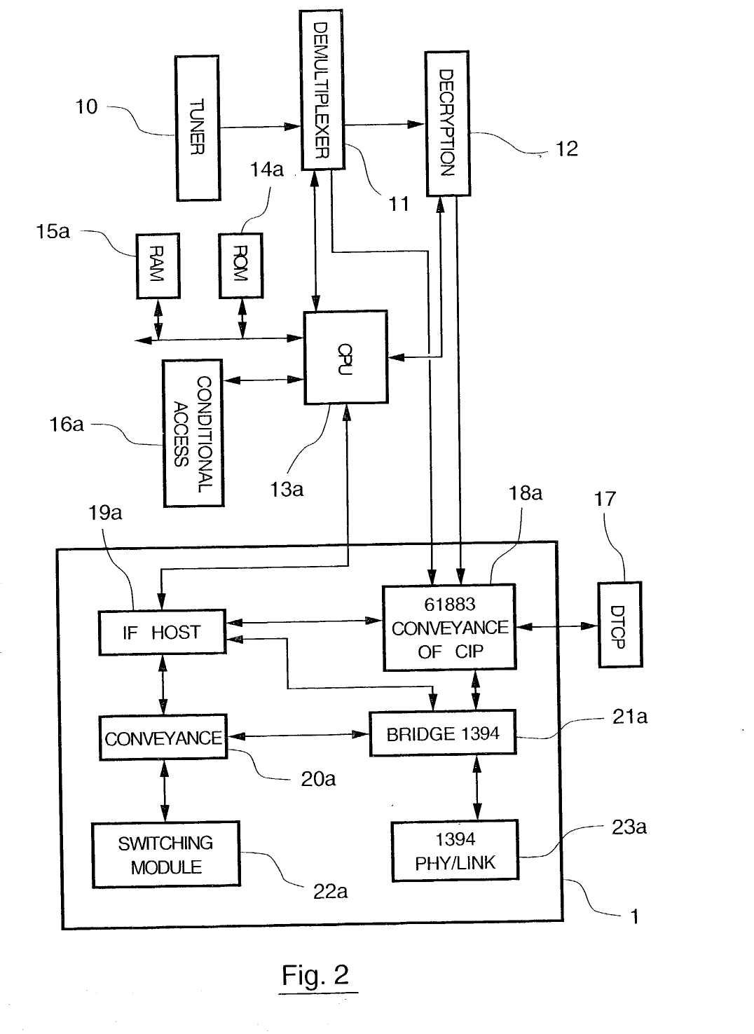

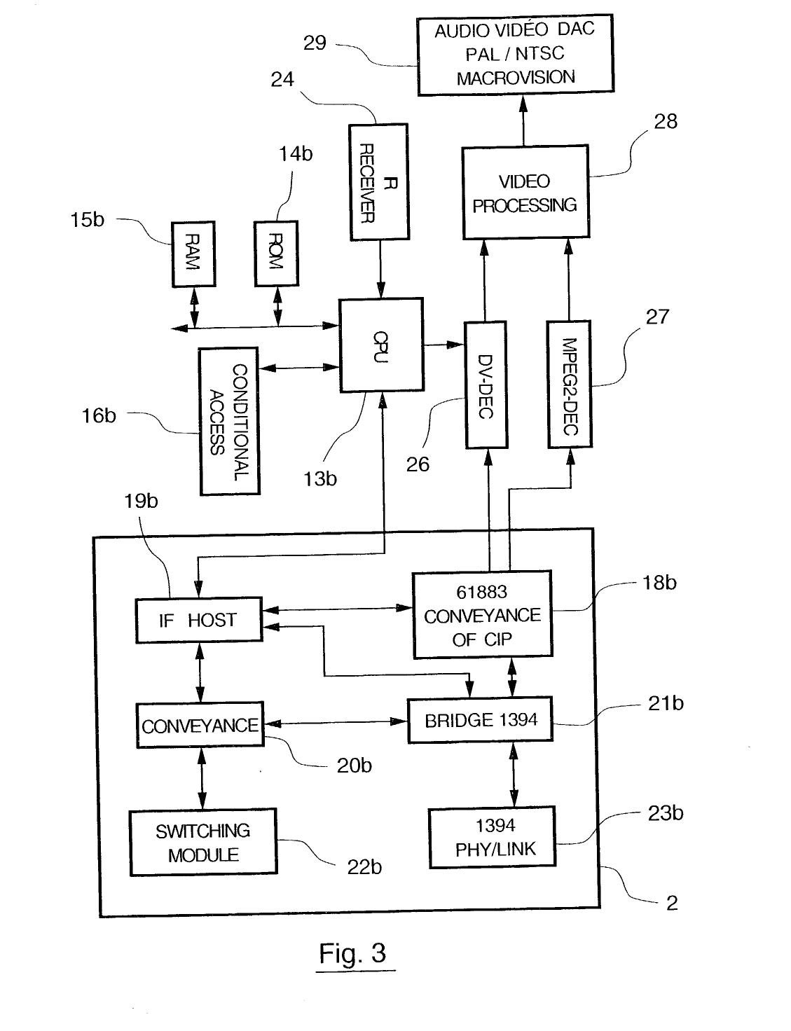

Here below, with reference to FIGS. 2 and 3, we shall present exemplary structures of a source node (FIG. 2) and a destination node (FIG. 3) belonging to a home audiovisual network according to the invention.

It may be recalled that a source node of this kind comprises, for example, a satellite data reception device for receiving for example data representing satellite television signals. A source node of this kind may of course also be any other device capable of receiving audiovisual signals and then introducing them into the home audiovisual network of the invention.

With a view to simplification, the rest of the document shall be limited to the case where the source node comprises a device for the reception of satellite television source signals. It will of course be easy for those skilled in the art to extend the following description to any type of source node.

The source node of FIG. 2 can be subdivided into two distinct parts:

a first set of elements (not referenced in FIG. 2) sees to the processing of the source signals received from a source external to the network, such as the source signals received on a satellite antenna for example;

a second set of elements 1 is designed to ensure the functionalities of the source node within the switched audiovisual network to which it belongs.

The first set of elements comprises:

a tuner 10 which, from the data received by a satellite antenna not shown in FIG. 2, extracts a channel multiplexing several audiovisual stations;

a demultiplexer 11 which demultiplexes the signals coming from the tuner 10, so as to select one of the audiovisual stations of the channel;

a decryption device 12 that decrypts the signals coming from the demultiplexer 11 so as to decrypt the audiovisual stations received in encrypted form by the source node;

a central processing unit (CPU) 13a;

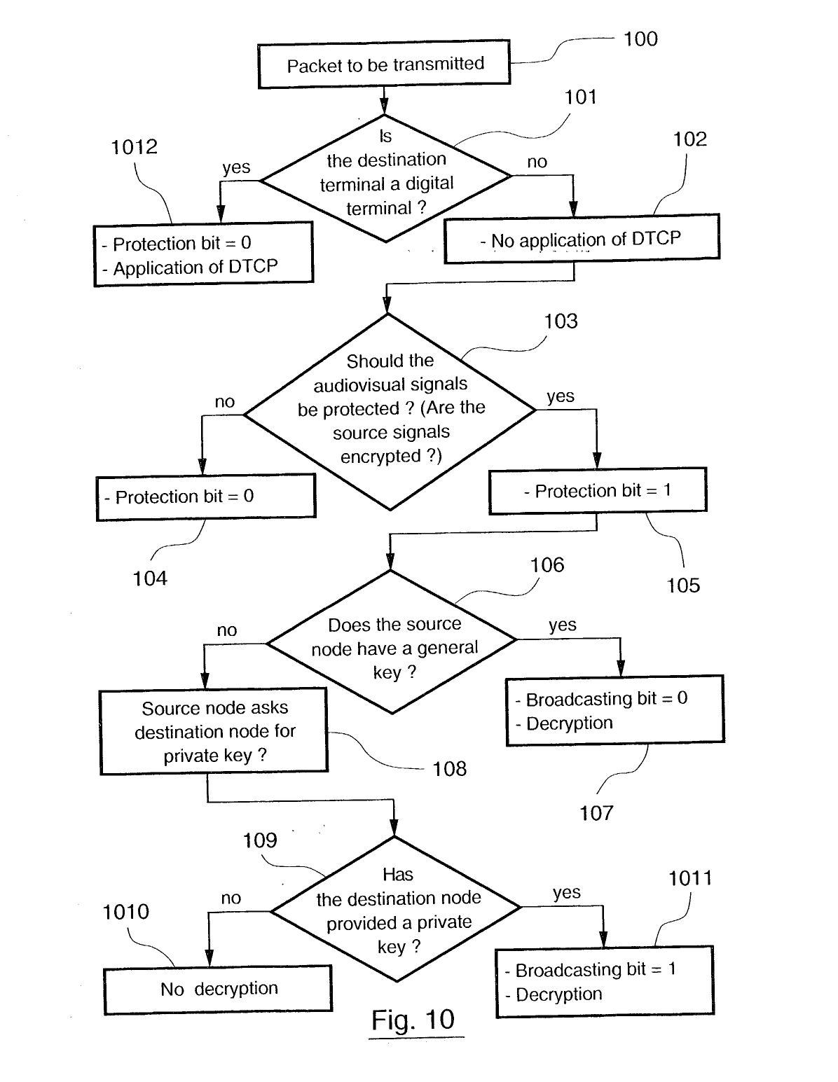

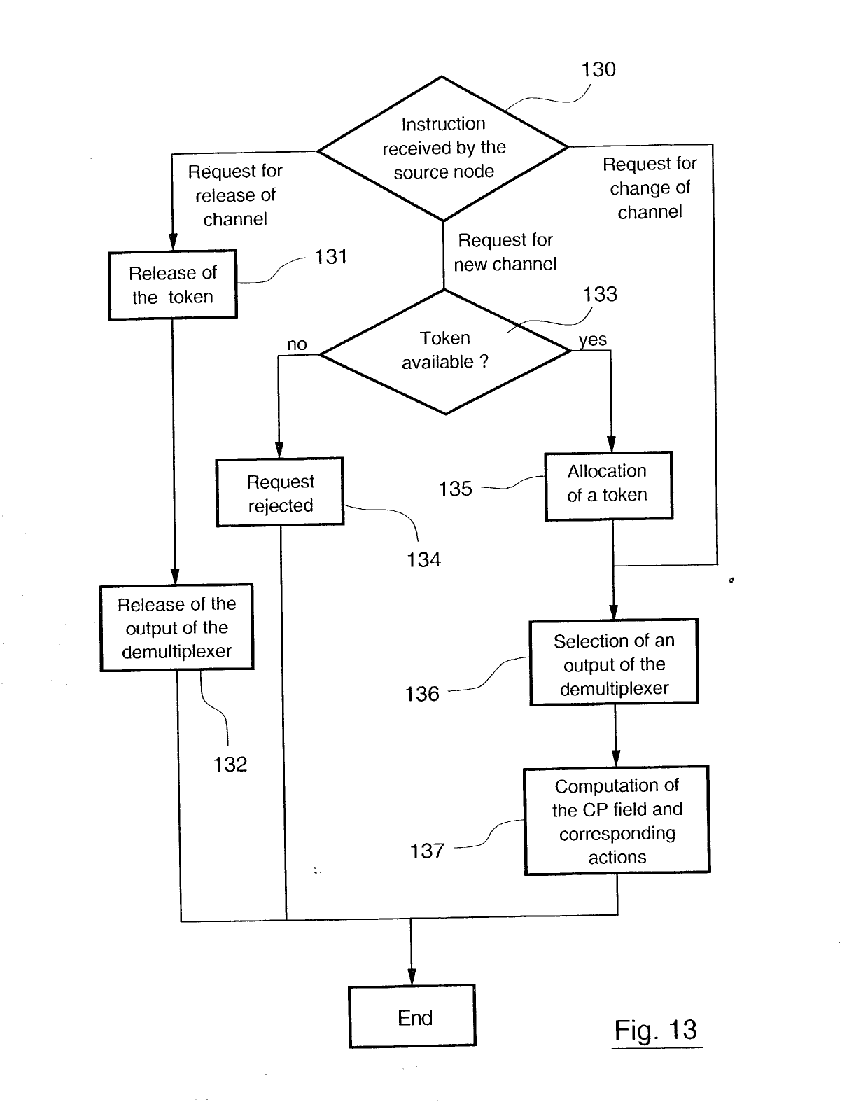

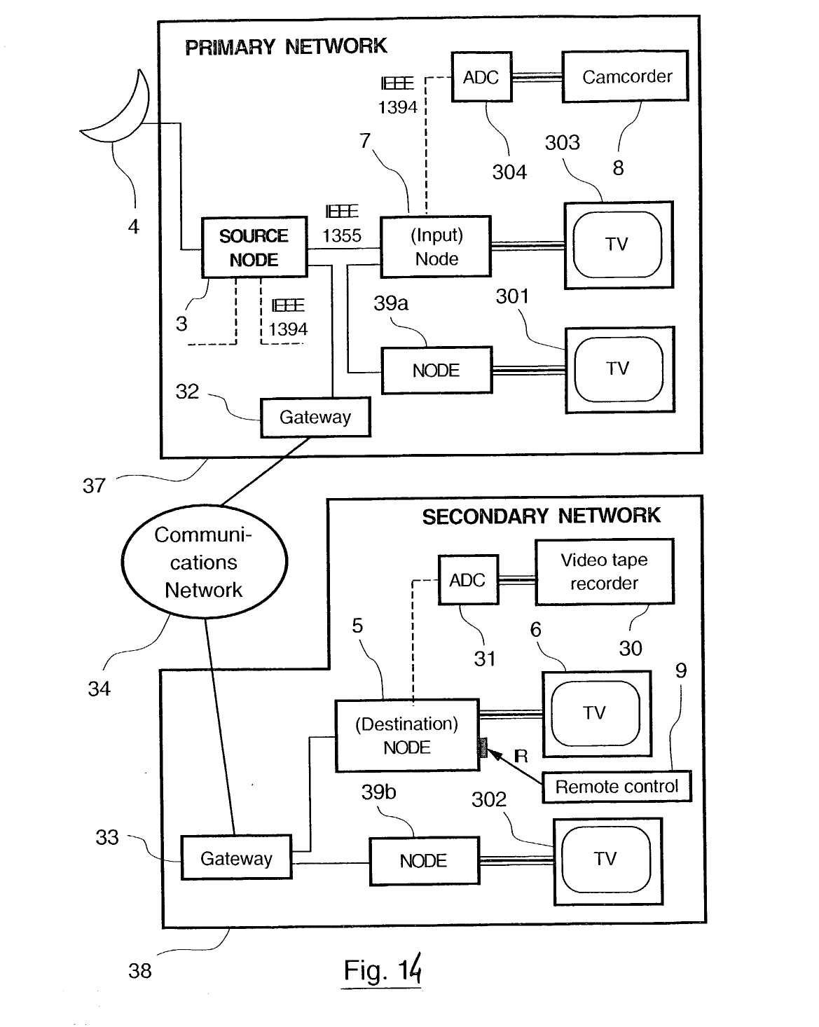

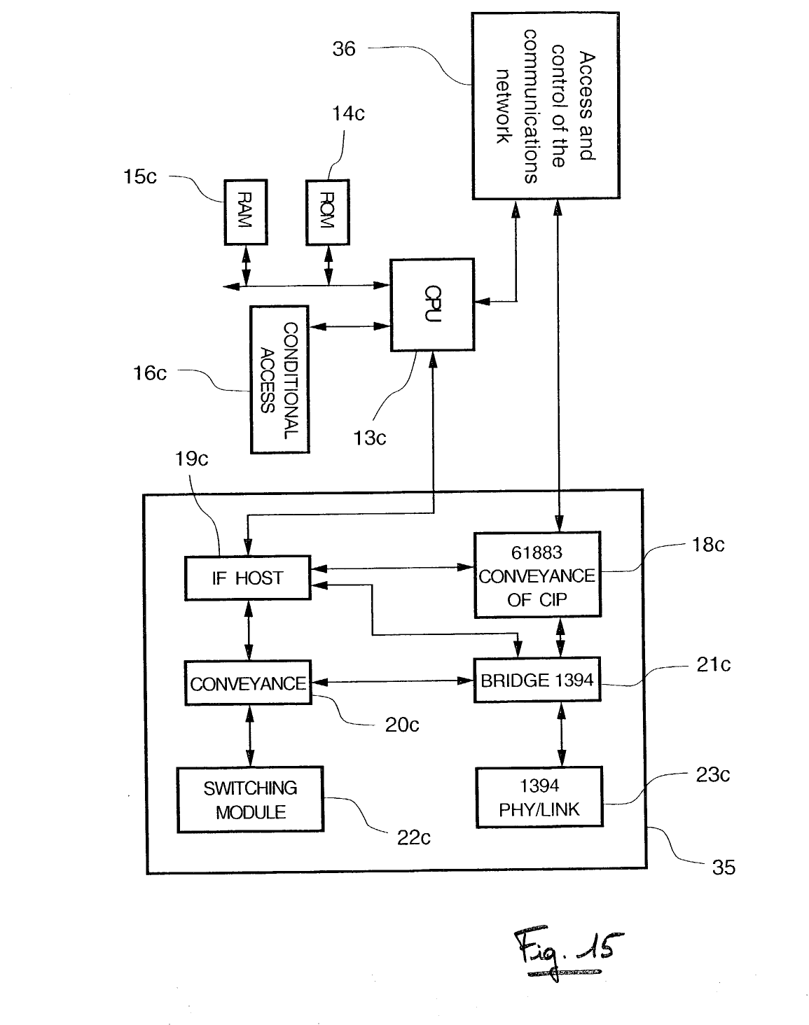

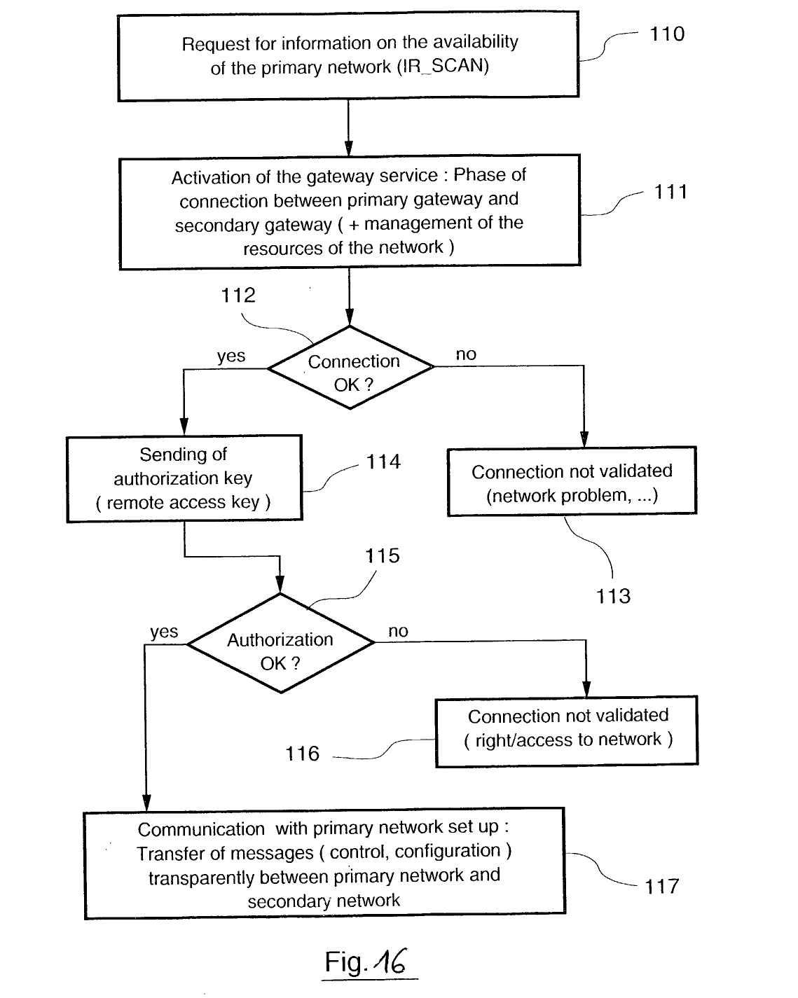

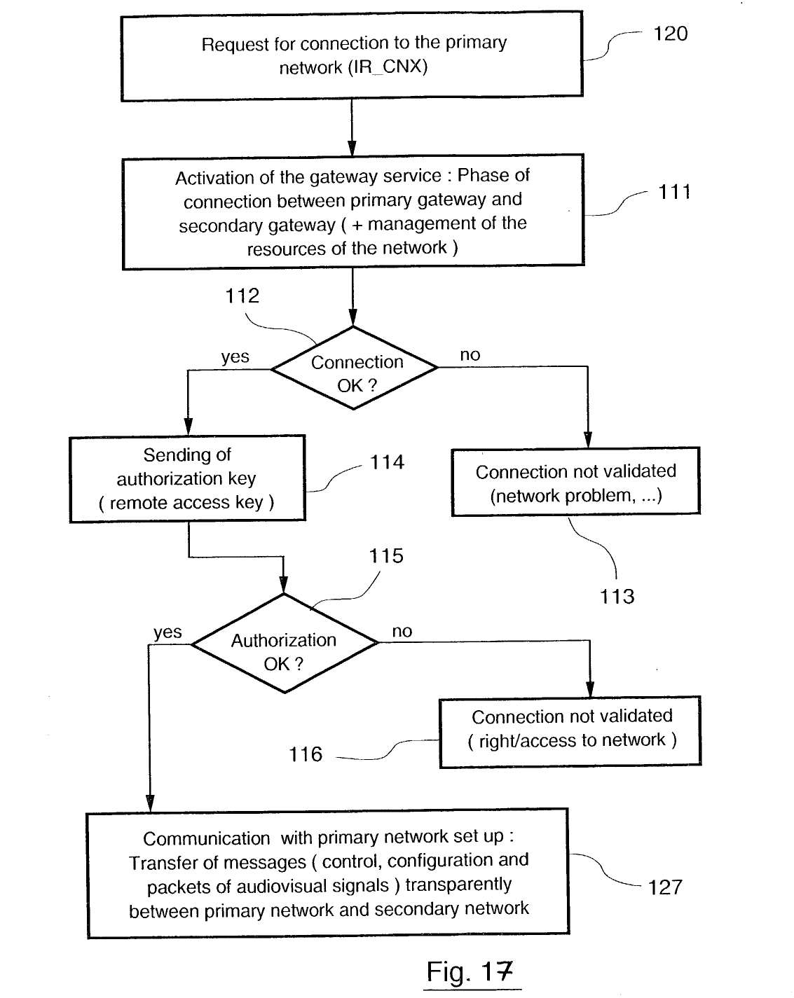

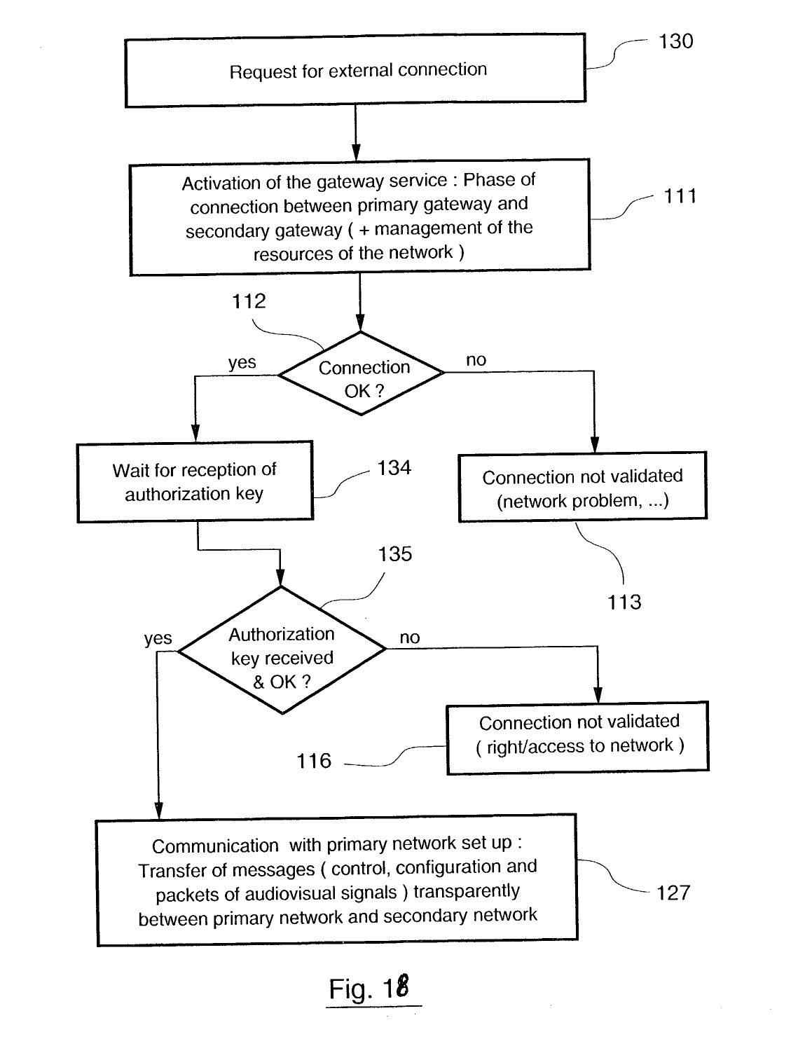

a ROM (read-only memory) type permanent storage means 14a that stores some of the algorithms proper to the invention described here below with reference to the FIGS. 10 and 13;

a RAM (random access memory) type of temporary storage means 15a;

a conditional access device 16a providing for the management and verification of keys used to control the access of the destination nodes of the network to certain audiovisual signals;

an audiovisual signal encoding module 17 in the DTCP (digital transmission copy protection) format as defined in the “Digital Transmission Content Protection Specification, Volume 1 (Informational Version), Revision 1.1, Jul. 25, 2000”, used for the application of a specific protection encoding to the audiovisual signals intended for a digital terminal. Only the digital terminals entitled to receive these audiovisual signals are equipped with a decoder having the corresponding DTCP format so that they can decode and then process the signal received.

The second set of elements 1 of the source node combines characteristic functional elements of technology implemented on the switched audiovisual network of the invention, and has at least two external input/output ports respectively connected to a serial communications bus designed to function according to the IEEE 1394 standard, and a switched network according to the IEEE 1355 standard.

It may be recalled that the IEEE 1394 standard is described in the following reference documents:

IEEE Std 1394-1995, Standard for High Performance Serial Bus;

IEEE Std 1394a-2000, Standard for High Performance Serial Bus;

IEEE P1394.1 Draft 0.17 Standard for High Performance Serial Bus Bridges.

The IEEE 1355 standard for its part is defined by the IEEE 1355-1995 Standard for Heterogeneous InterConnect (HIC) (Low Cost Low Latency Scalable Serial Interconnect) (also known as ISO/IEC 14575 DIS).

The set 1 comprises especially:

a block 18a for the conveyance of CIP (common isochronous packet) type packets according to the IEC 61883 standard as defined in the “International Standard Consumer Audio/Video Equipment—Digital Interface, First Edition, 1998-02, IEC 61883-1/2/3/4/5”. A block 18a of this kind is supplied with data coming from the demultiplexer 11 and the decryption device 12 and delivers CIP type packets after having registered their time and date. Thus, the block 18a inserts an absolute time information into the packets that it delivers, indicating when a packet has to be consumed by the application for which it is intended;

a module 19a that provides the interface with the central processing unit for the blocks referenced 18a, 20a and 21a;

a transportation module 20a made for example according to the FPGA technology used especially to insert an information for the control of the broadcasting and/or copying in the packet intended to be transmitted by the source node to the switched audiovisual network of the invention;

a device 21a known as a “1394 bridge” providing the interface, within the source node, between, firstly, the switched audiovisual network of the invention consisting of IEEE 1355 links and, secondly, a serial communications bus designed to work according to the IEEE 1394 standard to which the source node is attached;

a switching module 22a having an output port connected to the switched audiovisual network of the invention consisting of IEEE 1355 links;

an interfacing means 23a comprising a set of PHY/LINK 1394 components constituted for example by a component PHY TSB21LV03A and a component LINK TSB12LV01A commercially distributed by the firm Texas Instruments (Registered Mark) and 1394 connectors, for example commercially distributed by the firm MOLEX (Registered Mark) for example under the reference 53462. The interfacing means 103 comprises at least one external port designed to be connected to a terminal (data-processing device or peripheral), through a 1394 serial communications bus.

FIG. 3 illustrates an exemplary destination node according to the invention. The structure of a node of this kind is close to that of the source node described here above in that it comprises:

a first set of elements 2 combining functional elements characteristic of the technology implemented in the switched audiovisual network of the invention and having at least two input ports respectively connected to a serial communications bus designed to work according to the IEEE 1394 standard and a switched network according to the IEEE 1355 standard. Thus, a destination node can receive data packets by one of the three input/output ports of the switched node 22b coming from the switched audiovisual network consisting of IEEE 1355 type links or by one of the two input/output ports of the interfacing means 23b coming from a terminal (data processing device or peripheral) through a serial communications bus 1394;

a second set of elements not referenced in FIG. 3 providing for the processing of the data packets coming from the switched network of the invention, prior to their transfer to a terminal connected to the destination node. A terminal of this kind may be an analog or digital terminal.

The set 2 of FIG. 3 comprises elements similar to those of the set of elements 1 described with reference to FIG. 2, namely:

a block 18b for the conveyance of CIP (common isochronous packet) type packets according to the IEC 61883 standard;

a module 19b that provides the interface with the central processing unit for the blocks referenced 18a, 20a and 21a;

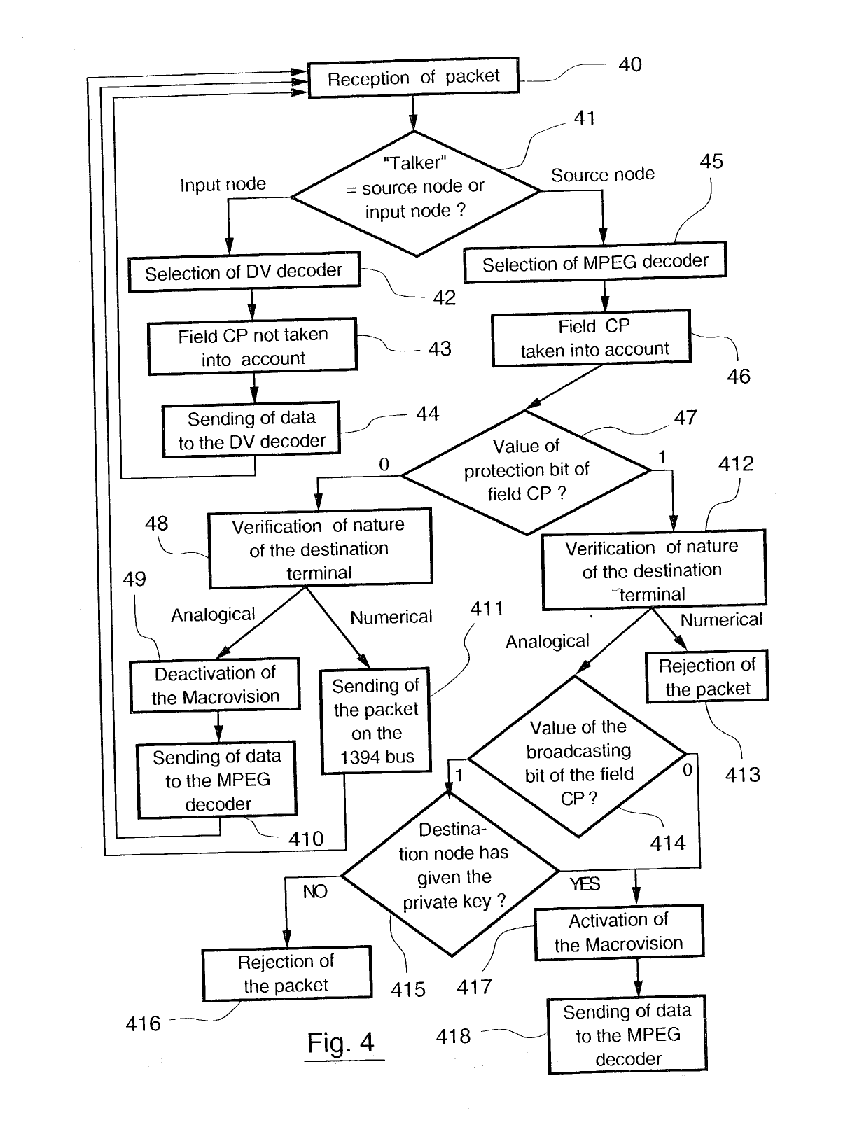

a transport module 20b providing for the processing of the above-mentioned control information. This module 20b comprises storage means storing and implementing especially the algorithm proper to the invention described here below with reference to FIG. 4;

a device 21b, known as a “1394 bridge,” providing the interface, within the source node, between the switched audiovisual network of the invention consisting of IEEE 1355 links and, secondly, a serial communications bus designed to work according to the IEEE 1394 standard to which the source node is attached;

a switching module 22b having three input/output ports connected to the switched audiovisual network of the invention consisting of IEEE 1355 links;

an interfacing means 23b comprising a set of PHY/LINK 1394 components.

The elements of the destination node that process the data packets prior to their transfer to a terminal connected to the destination node comprise:

a central processing unit or CPU 13b;

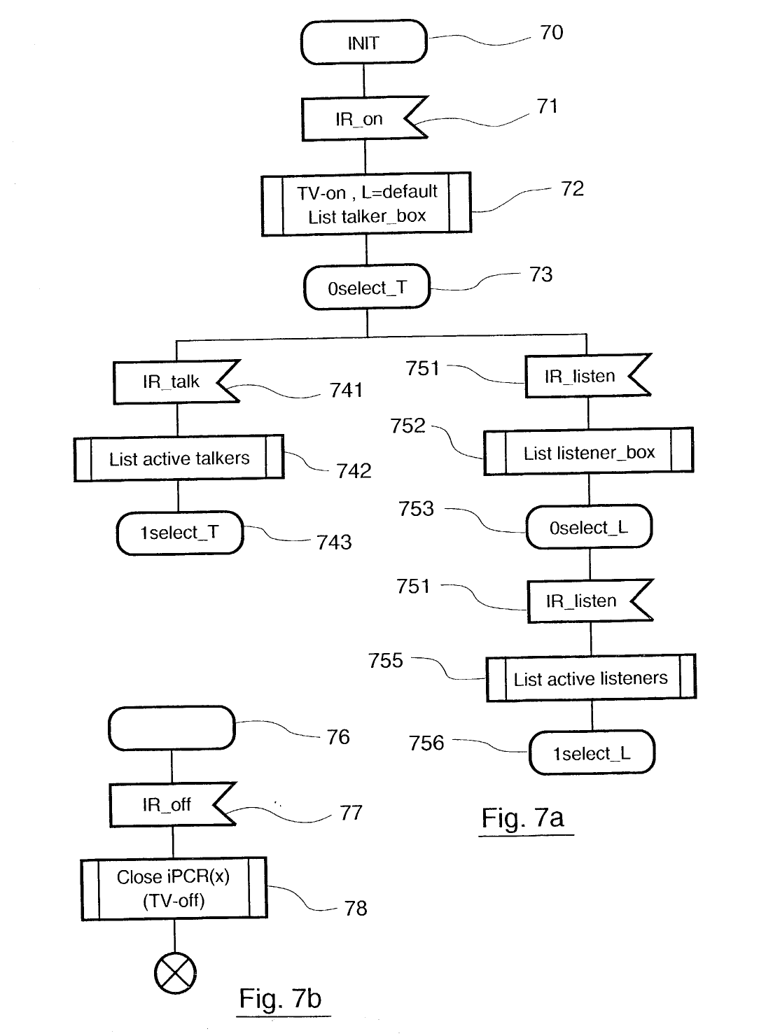

a ROM (read-only memory) type permanent storage means 14b, that stores some of the algorithms proper to the invention described here below with reference to the FIGS. 7 to 9, 11 and 12;

a RAM (random-access memory) type temporary storage means 15b;

a conditional access device 16b providing for the management of the local keys required by the source node to control the access of the destination nodes of the network to certain audiovisual signals;

an infrared reception device 24 providing for the reception of infrared signals emitted for example by a remote control type device intended for the destination node and their transmission to the central processing unit 13b;

a DV (digital video) format decoder 26 according to the DV IEC 61834 standard described in the document “Specifications of consumer-use digital VCRs using 6.3° mm magnetic tape”, published December 1994, “HD Digital VCR Conference”, providing for the decoding of audiovisual signals received by the destination node and encoded in the DV format;

a decoder 27 in the MPEG2 (Moving Pictures Expert Group, according to the ISO/IEC 13818-1, 13818-2, 13818-3 standard) format used for the decoding of audiovisual signals received by the destination node and encoded in the MPEG2 format;

a video processing module 28;

a module 29 providing firstly for the digital/analog conversion of audiovisual signals intended for an analog destination terminal connected to the destination node and secondly the activation of anti-copy means according to the “Macrovision” system (designed and developed by the firm Macrovision, registered mark) when the contents of the audiovisual signals intended for an analog destination terminal of this kind have to be protected. The module 29 comprises one or more analog output ports to which it is possible to connect one or more analog terminals such as a television set or a video tape recorder for example. It may be recalled that the activation of the “Macrovision” system scrambles the analog signal coming from the analog output port of the module 29, imperceptibly for television type analog terminals, but prevents the copying of such a signal by an analog copying terminal such as a video tape recorder.

It may be recalled that the packets are used to convey audiovisual signals from one node (source or input node) to another node (destination node). Thus, in the first illustrative case described here above, the packets convey for example MPEG2 format audiovisual signals from the source node 3 to the destination node 5. In the second above-mentioned illustrative case, the packets convey for example DV format audiovisual signals from the input node 7 to the destination node 5.

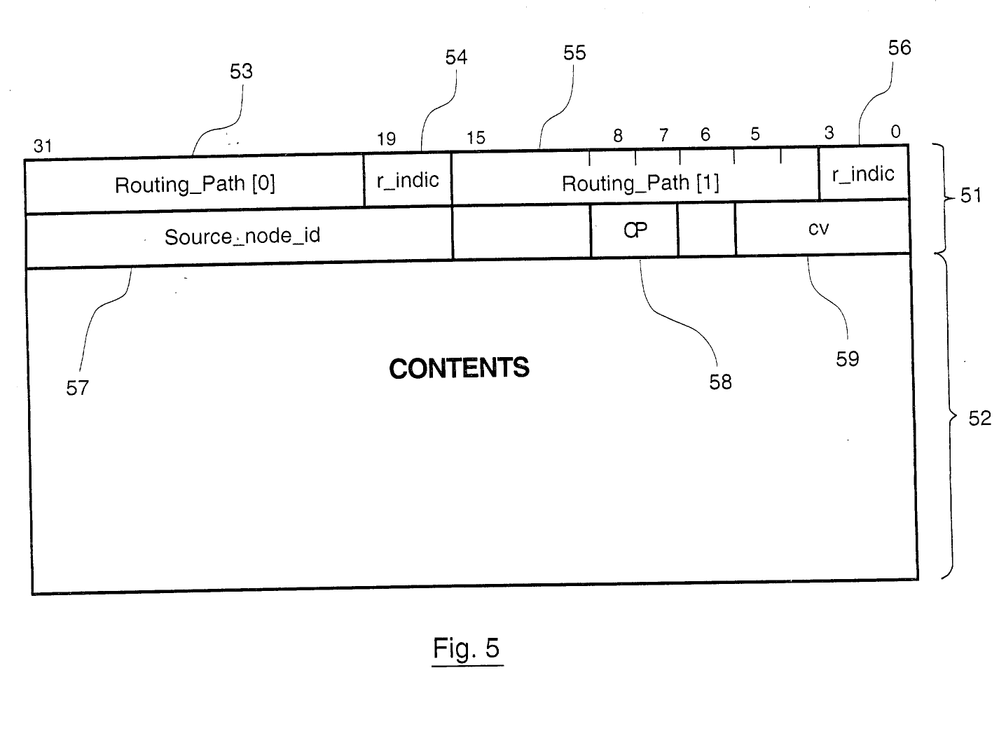

It is assumed hereinafter in the description that each packet has the particular structure illustrated in FIG. 5, comprising a header 51 and a data field (also called contents) 52.

The header 51 comprises:

fields referenced 53 to 56 pertaining to the routing of the packet. They are not concerned by the present invention and shall not be described in greater detail;

a “source_node_id” field 57 containing an identifier of the source node;

a “CP” field 58 containing, in a manner specific to the present invention, a piece of information to control the copying and/or broadcasting of the audiovisual signal conveyed by the data field 52 of the packet;

a cv field 59 containing a virtual channel identifier used to distinguish between different flows coming from one and the same source node (and hence to identify the destination terminal when several terminals connected to one and the same destination node receive audiovisual signals coming from one and the same source node).

As explained in detail hereinafter, the source node fills the field CP, i.e. it gives a value to the control information as a function of the nature (analog or digital) of the destination terminal, the level of protection to be applied to the audiovisual signal and broadcasting criteria, if any, to be applied.

The control information is for example encoded in the field CP on two bits: a first bit, called a protection bit, and a second bit called a broadcasting bit. The criteria by which the source node assigns the value 0 or 1 to each of these two bits, as well as the use by the destination node of these two bits, are described in detail hereinafter in the description.

Referring to the flow chart of FIG. 4, we shall now describe an exemplary algorithm for the processing of a packet, according to the invention, in a destination node of the home audiovisual network of FIG. 1.

This algorithm is stored in the ROM associated with the transport module. When the power is turned on, the transport module loads and executes the instructions corresponding to this algorithm.

After reception of a packet (step 40), the destination node finds out whether the transmitter device (“talker”) is a source node or an input node (step 41).

If the transmitter device (“talker”) is an input node 7 (second illustrated case mentioned here above), the destination node selects its DV decoder (step 42). The field CP is not taken into account (step 43). The data of the data field 52 of the packet are sent to the DV decoder (step 44).

If the transmitter equipment (“talker”) is a source 3 (first illustrative case mentioned here above), the destination node selects its MPEG decoder (step 45). The field CP is taken into account (step 46). The destination node analyzes the value of the protection bit of the field CP (step 47).

If the protection bit of the field CP takes the value “0”, the destination node verifies the nature of the destination terminal (television set 6 (“listener”) in the first and second above-mentioned illustrated cases) (step 48). If it is an analog terminal, the destination node deactivates the “Macrovision” (step 49) and sends the data from the data field 52 of the packet to the MPEG decoder (step 410). If it is a digital terminal, the packet is sent on the IEEE 1394 bus to which the digital terminal (step 411) is connected.

If the protection bit of the field CP assumes the value “1”, the destination node verifies the nature of the destination terminal 6 (step 412). If it is a digital terminal, the destination node rejects the packet (step 413). If it is an analog terminal, the destination node analyzes the value of the broadcasting bit of the field CP (step 414).

If the broadcasting bit of the field CP takes the value “1”, the destination node ascertains that it is the one which has first of all given the private key (step 415). If the answer is negative, the destination node rejects the packet (step 416). If the answer is affirmative, the destination node activates the “Macrovision” (step 417) and sends the data from the data field 52 of the packet to the MPEG decoder (step 418).

If the broadcasting bit of the field CP takes the value “0”, the steps 417 and 418 discussed here above are performed directly.

Referring to the flow chart of FIG. 10, we shall now describe an exemplary algorithm for the processing of a packet, according to the invention, in a source node of the home audiovisual network of FIG. 1.

This algorithm is stored in the ROM of the source node. It is loaded into the RAM when the power is turned on and the central processing unit (CPU) will execute the instructions corresponding to this algorithm.

Before sending a packet (step 100), the destination node detects the nature of the destination terminal (television set 6 in the first and second illustrative cases mentioned here above) (step 101).

If the destination terminal (“listener”) is a digital terminal, the source node assigns the value “0” to the protection bit of the field CP and applies a DTCP type encoding (step 101).

If the destination terminal (“listener”) is not a digital terminal (i.e. if it is an analog terminal), the source node does not apply the DTCP type encoding (step 102). It finds out whether the audiovisual signal has to be protected (namely for example if the source signals are encrypted and do not have to be decrypted except under certain conditions) (step 103).

If the audiovisual signals do not have to be protected, the source node assigns the value “0” to the protection bit of the field CP (step 104).

If the audiovisual signals have to be protected, the source node assigns the value “1” to the protection bit of the field CP (step 105). Then the destination node finds out if it has an overall key (step 106). If it does, it assigns the value “0” to the broadcasting bit of the field CP and carries out a decryption (step 107). If not, the source node requests the destination node for a private key (also called a local key) (step 108). If the destination node gives the private key (response “yes” to the step referenced 109), the source node assigns the value “1” to the broadcasting bit of the field CP and carries out a decryption (step 1011). If the destination node does not give the private key (response “no” to the step referenced 109), the source node does not perform any decryption (step 1010).

It will be recalled that the terms active destination terminal (“listener”) and active transmitter device (“talker”) refer to two entities involved in a connection within the home audiovisual network.

It is assumed that the system (and therefore the nodes of the network) have:

the full list of active destination terminals (“listeners”);

the full list of the active transmitter devices (“talkers”).

When he wishes to set up a connection between a transmitter device (“talker”) and a destination terminal (“listener”), the user has several possibilities:

either he directly identifies this transmitter device and/or this destination terminal (for example by entering a specific identifier for each);

or he chooses this transmitter device from within a sub-list of active transmitter devices (“talkers”) which the system allows him to view and/or he chooses this destination terminal within a sub-list of active destination terminals (“listeners”) that the system also allows him to view.

In a first embodiment, each sub-list is taken to be the same as the corresponding full list. In this case, the user may view all the active transmitter devices (“talkers”) and/or all the active destination terminals (“listeners”).

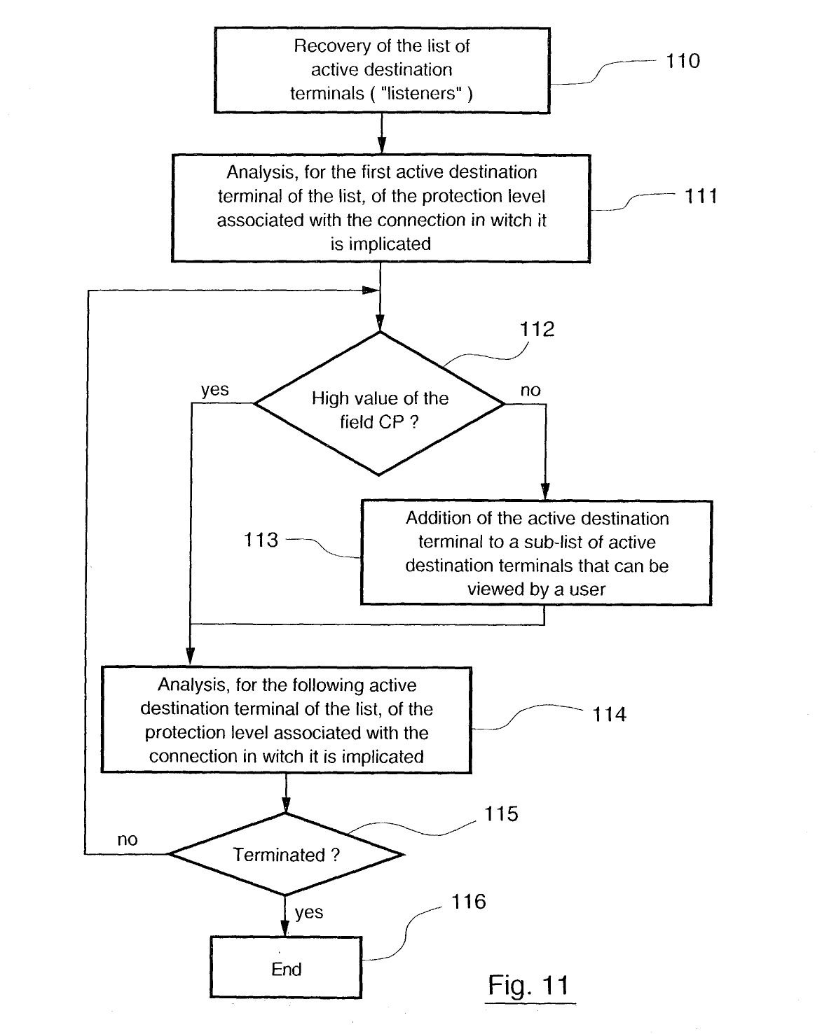

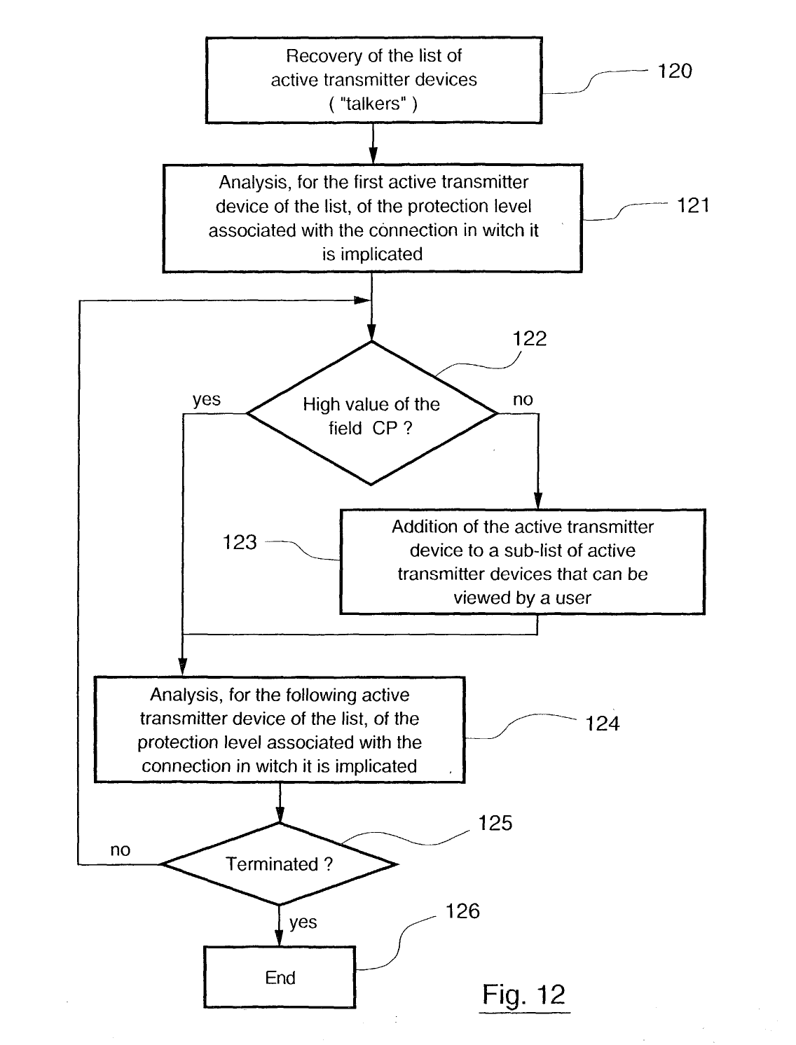

In a second embodiment, each sub-list that can be viewed by the user is limited to a part of the corresponding complete list as a function of at least one predetermined filtering criterion. As explained here below with reference to FIGS. 11 and 12, this filtering criterion is for example related to the protection level (value of the field CP) associated with each connection in which an active transmitter device and an active destination terminal are involved.

Referring to the flow chart of FIG. 11, we shall now present an exemplary algorithm for the creation of a sub-list of active destination terminals (“listeners”) that can be viewed by a user.

This algorithm is, for example stored in the ROM of the destination node (should this destination node fulfil the role of the control unit). It is loaded into the RAM when the power is turned on and the central processing unit (CPU) will execute the instructions corresponding to this algorithm.

After recovering the full list of active destination terminals (step 110), an analysis is made, for the first active destination terminal of the list, of the protection level associated with the connection in which this destination terminal is involved (step 111).

In other words, the value of the field CP associated with this connection is analyzed. It may be recalled that the field CP comprises:

a protection bit which takes the value “1” if it is sought to prohibit the copying of the audiovisual signals contained in the data field of the corresponding packet. The protection bit takes the value “0” if no protection of the audiovisual signals is necessary;

a broadcasting bit which takes the value “1” if no destination terminal is to be permitted to shunt (“spy function”) the audiovisual signals received by the destination terminal that has given the private key. The broadcasting bit takes the value “0” if not.

If the field CP does not take the high value (response “no” to the question of the step referenced 112), the active destination terminal is added to the sub-list of active destination terminals that the user will view (step 113) and then there is a passage to the following active destination terminal of the full list (step 114). The term high value of the field CP is understood to mean the case where the protection bit and the broadcasting bit each take the value “1”.

If the field CP takes the high value (response “yes” to the question of the step referenced 112), there is a direct passage to the following active destination terminal of the full list (step 114).

This mechanism is repeated until all the active destination terminals of the full list have been analyzed (step 115).

Referring now to the flow chart of FIG. 12, we shall now present an exemplary algorithm for the creation of a sub-list of active transmitter devices (“talkers”) that can be viewed by a user.

This algorithm is, for example stored in the ROM of the destination node (should this destination node fulfil the role of a control unit). It is loaded into the RAM when the power is turned on and the central processing unit (CPU) will execute the instructions corresponding to this algorithm.

After recovering the full list of active transmitter devices (step 120), an analysis is made, for the first active transmitter device of the list, of the protection level associated with the connection in which this transmitter device is involved (step 121).

If the field CP does not take the high value (response “no” to the question of the step referenced 122), the active transmitter device is added to the sub-list of active transmitter devices that the user will view (step 123) and then there is a passage to the following active transmitter device of the full list (step 124).

If the field CP takes the high value (response “yes” to the question of the step referenced 122), there is a direct passage to the following active transmitter device of the full list (step 124).

This mechanism is repeated until all the active transmitter devices of the full list have been analyzed (step 115).

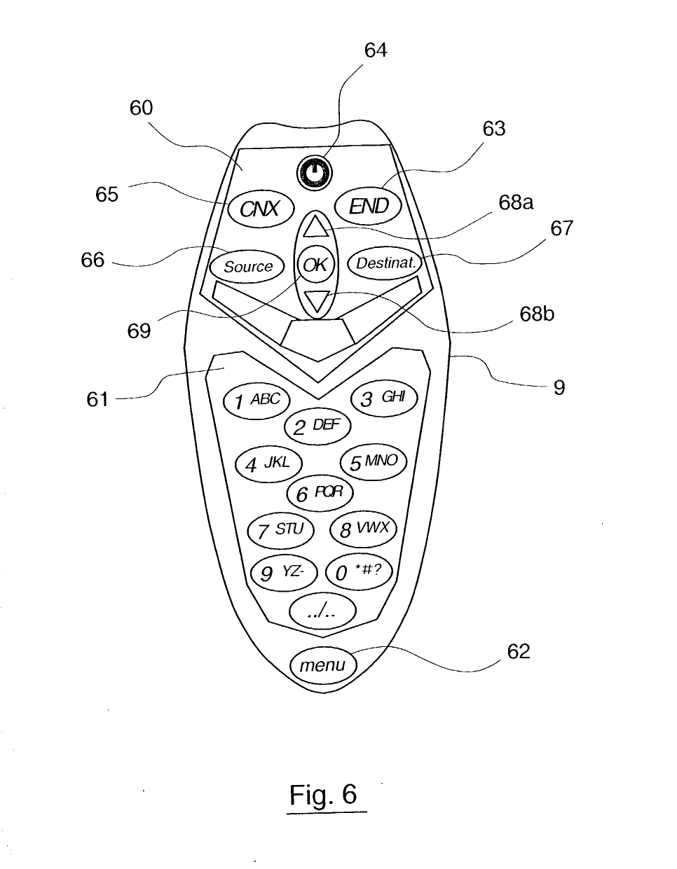

FIG. 6 illustrates an exemplary remote control pack 9 that can be used in an embodiment of the invention, in the context of a man/machine interface between a user and a node of the home audiovisual network. It may be recalled indeed that a home audiovisual network, in a preferred embodiment of the invention, has an infrared type input interface through which data can be sent from a remote control pack 9 to the node.

A pack 9 of this kind comprises for example three sets of keys:

a first set of keys referenced 60, comprising specific control keys;

a second set of alphanumerical keys referenced 61;

a key referenced 62 enabling a user to access a menu, for example a menu of complementary functionalities that could be implemented within the audiovisual network of the invention but shall not be described in greater detail in the context of the present patent application.

The set of control keys referenced 60 comprises for example:

a button referenced 64 used to control the standby or resume activity state of the node of the audiovisual network associated with the remote control pack 9;

two keys; a Source key referenced 66 and a “Destination” key referenced 67, by which a particular terminal of the audiovisual network can be selected. The “Source” key referenced 66 enables the user to select a transmitter device (namely a source node or an input terminal also called a “talker”) of the audiovisual network of the invention. The “Destination” key referenced 67 enables a user to select a destination terminal of the audiovisual network of the invention, for example the television set referenced 6 of FIG. 1;

a connection key “CNX” referenced 65 used to set up a connection between the transmitter equipment and the destination terminal selected by means of the keys referenced 66 and 67 described here above;

an “END” button referenced 63 that can serve as an end button for the active key or to put an end to any specific processing performed by the local node controlled by the remote control pack 9. For example the key “END” referenced 63 is used to turn off a transmitter device to which the destination node considered is connected;

up and down navigation buttons respectively referenced 68a and 68b enabling the user to move up or down in a menu or a list;

an “OK” button referenced 69 used to validate the selection of an item of a list or a menu.

The alphanumerical keys of the set referenced 61 enable a user to select an item referenced by means of an alphanumerical character within a list or a menu or again to enter a string of alphanumerical characters by means of a remote control 9.

A description is given here below in greater detail, with reference to FIGS. 7 to 9, of exemplary algorithms of the operation of the destination node as a function of the commands that it receives from the infrared remote control pack 9.

It will be noted that the instructions in the flow charts of FIGS. 7 to 9 are expressed in computer terminology used for the programming of the remote control pack 9 and the destination node 5 that is associated with it.

The algorithm described with reference to FIG. 7 is stored in the ROM of the destination node. When the power is turned on, this algorithm is loaded into the RAM and the central processing unit (CPU) will execute the instructions corresponding to this algorithm.

The operation starts from an initial state “init” referenced 70. A user activates the button referenced 64 of the remote control 9, thus activating the dispatch of a command “IR_on” referenced 71 to the destination node 5. During a step referenced 72, a default list is made of all the nodes of the audiovisual network connected to or comprising a transmitter device (a “talker”), according to the instruction “List talker_box”. For example, a list of this kind may take the following form:

parents' room;

television room;

kitchen.

By default, the television set referenced 6 connected to the destination node 5 constitutes the “listener” or destination terminal according to the instruction “TV-on, L=default”.

The destination node 5 then goes into a state referenced 73 “0select_T”.

Then two possibilities are offered to the user:

if he activates the key “Source” referenced 66, the destination node receives an instruction referenced 741 “IR_talk”, and lists (742) all the active transmitter equipment (“talkers”) within the audiovisual network of the invention. A list of this kind may for example be displayed on a screen of the destination node 5 or on the television set 6 that is connected thereto, so that the user can obtain knowledge thereof. Such a list may take the following form:

equipment AV1 of the television room;

equipment AV3 of the television room;

equipment AV2 of the kitchen.

The destination node 5 then goes into a state “1select_T” referenced 743;

if he activates the key “Destination” referenced 67, the destination node receives an instruction referenced 751 “IR_listen” and lists (752) all the nodes of the audiovisual network of the invention to which one or more destination terminals are connected. A list of this kind may take the following form:

parents' room;

children's room;

television room;

kitchen.

The destination node 5 then goes into a state “0select_L” referenced 753. If it receives an instruction “IR_listen” referenced 751 from the remote control 9, the destination node 5 lists (755) all the active destination terminals (“listeners) within the audiovisual network of the invention. Again, a list of this kind can be displayed on a screen of the destination node 5 or on the television 6 that is connected to it so that the user can obtain knowledge thereof. A list of this kind can take the following form:

children's room/television room indicating that a destination terminal of the children's room is active and connected to a transmitter device of the television room;

television room/television room;

kitchen/kitchen.

The destination node 5 then goes into a state “0select_L” referenced 756.

It will be noted that, in a particular embodiment of the invention, the destination node 5, during the steps referenced 742 and 755, can display only a subset of the active transmitter devices or the active destination terminals within the network. A subset of this kind is for example determined as a function of a predetermined criterion related to the information on the control of the broadcast and/or the copying associated with the signal sent (or received respectively) by the transmitter equipment (and the destination terminal respectively). The display of such partial lists is described in greater detail with reference to FIGS. 11 and 12.

FIG. 7b illustrates the working of the destination node 5 when, from any initial state referenced 76, it receives an instruction “IR_off” referenced 77. This algorithm is stored in the ROM of the destination node. It is loaded into the RAM when the power is turned on and the central processor unit (CPU) will execute the instructions corresponding to this algorithm. The destination node then implements the instruction referenced 78 “Close iPCR(x) (TV-off)” which, in a preferred embodiment of the invention, consists in ending the connection between the destination node 5 and the analog television set referenced 6 that is connected thereto, if such a connection exists.

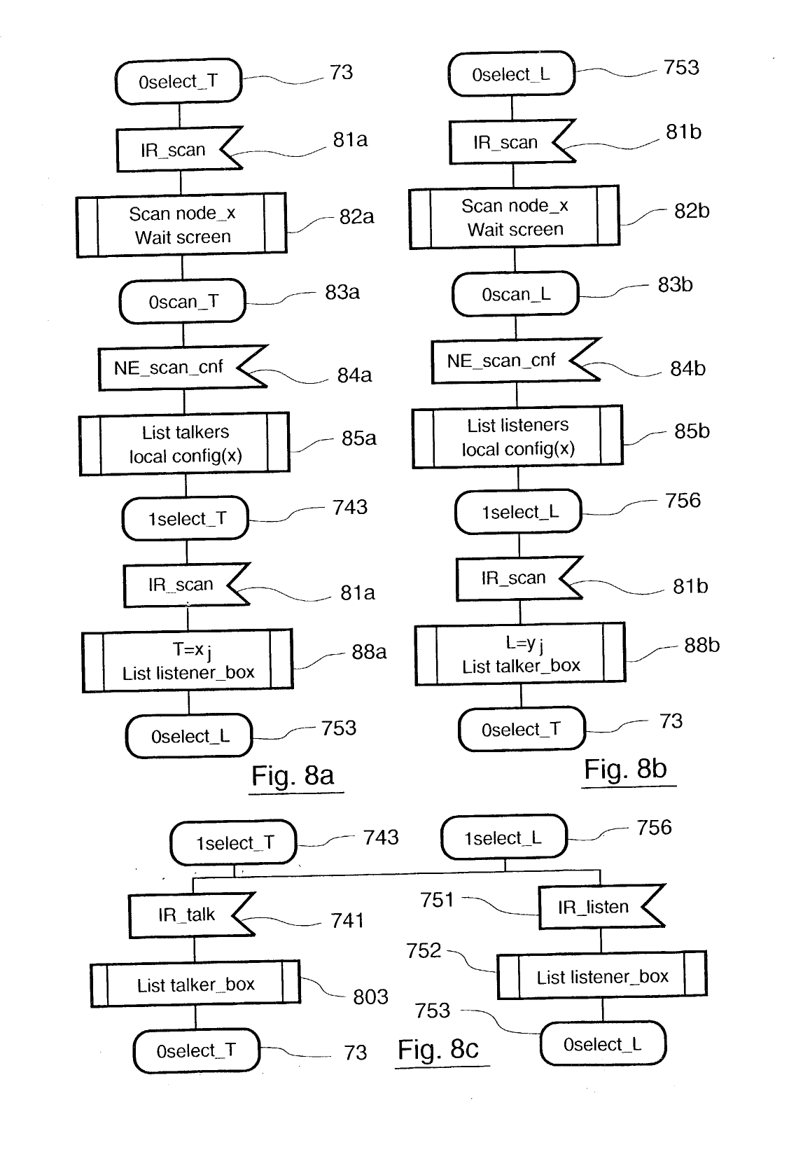

A description is given, at the same time, of FIGS. 8a and 8b respectively enabling a user to make the destination node 5 go from a state “0select_T” to a state “0select_L” or vice versa.

These algorithms are stored in the ROM of the source node. They are loaded into the RAM when the power is turned on and the central processing unit (CPU) will execute the instructions corresponding to these algorithms.

The destination node 5 is in an initial state “0select_T” referenced 73 (respectively “0select_L” referenced 753) and receives a command “IR_scan” referenced 81a (and 81b respectively) from the user through the remote control 9. It is recalled, with reference to FIG. 7a, that in the state “0select_T” referenced 73 (and respectively in the state “0select_L” referenced 753), the user has the list of nodes connected to or comprising transmitter equipment (respectively connected to one or more destination terminals).

The instruction “IR_scan” is received following the activation by the user of one of the navigation keys or one of the alphanumerical keys of the remote control 9 by which he can go through one of the lists of nodes described here above.

The destination node 5 implements the corresponding action “Scan node_x Wait screen” referenced 82a (and 82b respectively) and goes to the state “0scan T” referenced 83a (and respectively “0scan_L” referenced 83b). In a particular embodiment of the invention, the destination node 5 then displays a message of the “Scan TV room” type indicating the search for transmitter devices connected to the node located in the television room.

Upon reception of an instruction “NE_scan_cnf” referenced 84a (and 84b respectively), corresponding to the reception of the information sought at the node x of the selected network, the destination node 5 displays the list referenced 85a (and 85b respectively) of the transmitter devices belonging to or connected to the selected node x (and respectively the destination terminals connected to this selected node x). For example, the destination node 5 displays the names of the pieces of equipment VCR-1 and STB-2 connected to the node located in the television room. The destination node 5 then goes into the state “1select_T” referenced 743 (and the state “1select_L” referenced 756 respectively).

A new instruction “IR_scan” referenced 81a (and 81b respectively) validates the choice of a particular transmitter device (“talker”) xⱼ (and respectively a particular destination terminal (“listener”) yⱼ). By default, the destination node again displays the list referenced 88a (and 88b respectively) of the nodes connected to a destination terminal (and to a transmitter device respectively), for example of the type:

parents' room;

children s room;

television room;

kitchen.

The destination node goes back to the state “0select_L” referenced 753 (and respectively “0select_T” referenced 73).

From any one of the states “Iselect_T” referenced 743 and “Iselect_L” referenced 756 of FIG. 8c, the reception by the destination node 5 of an instruction “IR_talk” referenced 741 prompts the display of the list 803 of the nodes of the network connected to or comprising a transmitter device and the passage of the node 5 into the state “0select_T” referenced 73. Similarly, the reception of an instruction “IR_listen” referenced 751 prompts the display of the list 752 of the nodes of the network connected to a destination terminal and the passage of the node 5 into the state “0select_L” referenced 753. It will be recalled that the instructions “IR_talk” and “IR_listen” may be activated respectively by activating the keys “Source” referenced 66 and “Destination” referenced 67.

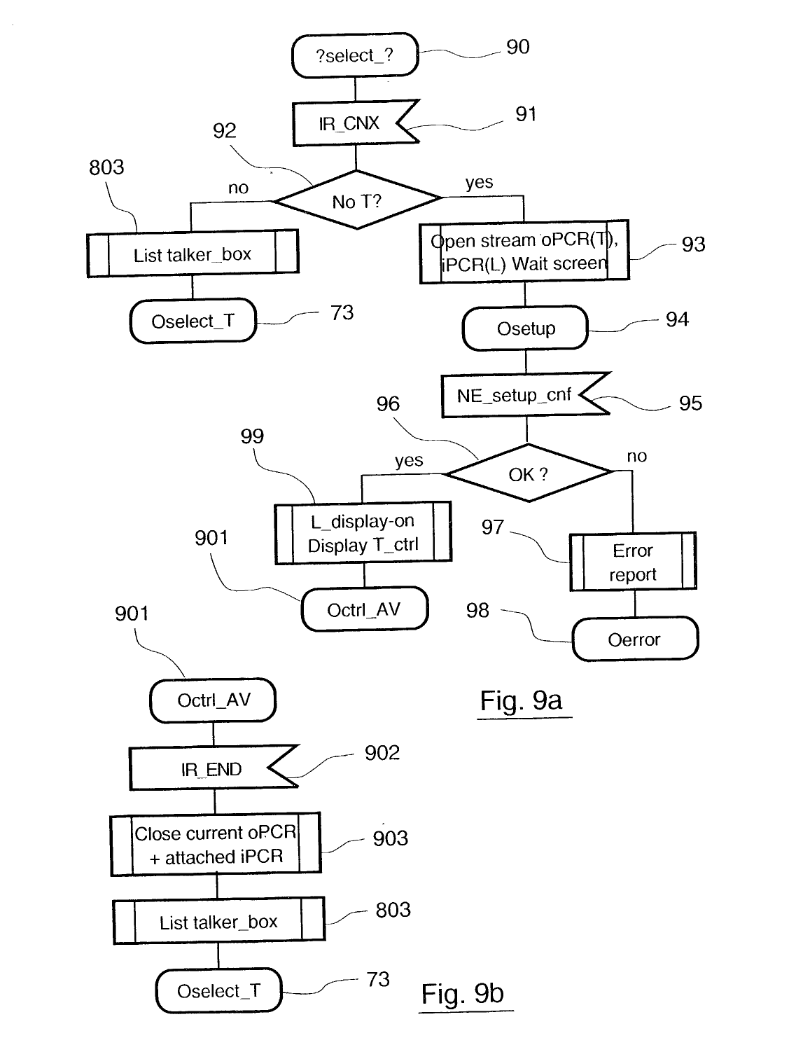

FIGS. 9a and 9b show algorithms of operation of the destination node 5 when the user wishes to put an end to a connection between a destination terminal (“listener”) and a transmitter device (“talker”).

These algorithms are stored in the ROM of the destination node. They are loaded into the RAM when the power is turned on and the central processing unit (CPU) will execute the instructions corresponding to these algorithms.

The destination node 5 is in any state referenced 90 which may for example be the state “0select_L” or “1select_T”. The user presses the key “CNX” referenced 65 of the remote control 9 and the destination node 5 therefore receives an instruction “IR_CNX” referenced 91.

The destination node 5 verifies (92) whether a “talker” has been selected by the user. It may be recalled that, in a preferred embodiment of the invention, the analog television 6 connected to the destination node 5 is chosen as a “listener” by default.

If no “talker” has been selected, the destination node displays the list referenced 803 of the nodes connected to or comprising a transmitter device or goes into the “0select_T” state referenced 73.

Otherwise, the destination node requests the setting up of a connection between the “talker” and the “listener” chosen by the user (or chosen by default) during an operation referenced 93 “Open stream oPCR(T), iPCR(L)”, and displays a waiting message “Wait screen” destined for the user.

During the operation referenced 93, the registers iPCR (“input Plug Control Register”) (or oPCR “output Plug Control Register respectively) are updated at the “talker” (“listener” respectively). These registers are described in the IEC 61883 standard.

The destination node goes into the “Osetup” state referenced 94 and then receives an instruction “NE_setup_cnf” referenced 95 coming from the network (for example coming from a specific processor unit of the network, responsible in particular for the management of the connections between a transmitter device and a destination terminal) informing it of the result of the request for connection referenced 93. The destination node 5 verifies (96) the confirmation of connection 95 received from the network.

If the connection has truly been set up between the destination terminal and the transmitter device, the listening function of the destination terminal is activated (99) by the command “L_display_on” and the transmission function of the transmitter device is activated by the “Display T_ctrl” command.

The destination node then goes to the state “Octrl_AV” referenced 901.

If there is a failure of the connection, the destination node 5 displays an error message by the command “Error report” referenced 97 and goes to the state “0error” referenced 98.

If the destination node 5 is in the state “0ctrl_AV” referenced 901, the reception of an instruction “IR_END” referenced 902 (corresponding to the activation by the user of the key referenced 63 of the remote control pack 9) leads to the closing of the current connection between a “talker” and a “listener” by the “Close current oPCR+attached iPCR” command referenced 903.

The destination node 5 then displays the list 803 of the nodes connected to or comprising a transmitter equipment (“talker”) and goes to the state “0select_T” referenced 73.

Referring now to the flow chart of FIG. 13, we shall present an algorithm for the implementation, in the source node 3, of the token-using mechanism according to the invention.

This algorithm is, for example stored in the ROM of the source node. It is loaded into the RAM when the power is turned on and the central processing unit (CPU) will execute the instructions corresponding to this algorithm.

It is assumed that the source node (Tuner unit”) receives an instruction (or request) that pertains to the channel that it manages and is a function of an action formed by the user (step 130).

It is possible to distinguish three types of request by the user:

“request for the release of the channel”: for example the user turns off a destination terminal (for example a television set) to which the source node was transmitting audiovisual signals relating to a given channel through a destination node;

request for a new channel: for example the user, through a destination node (for example by means of an infrared remote control), formulates a request for the reception, on a given destination terminal, of the audiovisual signals corresponding to a given channel;

“channel changing request”: for example the user, working through a destination node, formulates a request for a change, on a given destination terminal, of the channel that he receives coming from the source node.

A detailed description is now given of the actions of the source node associated with these three types of request from the user.

If the request is of the channel release request “type, the source node releases the token assigned beforehand to this channel (between the source node and a given destination terminal) (step 131). Then the node releases the output of the multiplexer that corresponds to the released channel (step 132).

If it is a “new channel request” type of request, the source node looks for an available token (step 133). If no token is available, the user's request is rejected (134). If not, a token is allocated to the new channel requested by the user (step 135). Then, the source node selects an output of the demultiplexer in order to associated it with the released channel (step 136). Finally, the source node computes and assigns a value to the field CP of the header of each packet conveying the audiovisual signals of this new channel (step 137). This step 137 is described in detail here below with reference to the flow chart of FIG. 10.

If it is a “request for channel change” type of request, the source node directly performs the steps referenced 136 and 137 and discussed here above. In other words, in this particular embodiment, the user may change channels while the same time keeping the same token.

It is clear that the invention also relates to the variant according to which, when the user changes channels, the token allocated to the previous channel is released and a new search has to be made for an available token (steps 133 and following steps). This variant is valuable for example if the tokens are of the dedicated type (and not of the generic type), i.e. if each of these tokens enables access to a particular channel (with which particular audiovisual signals are associated).

Referring now to the block diagram of FIG. 14, we shall describe a primary home audiovisual network connected by a set of two gateways to a secondary home audiovisual network, in which the present invention can be implemented.

It will be recalled that the primary or secondary home audiovisual network is of the type comprising a plurality of nodes enabling the interconnection of a plurality of audiovisual terminals.

In the preferred embodiment of the invention, the switched cores of the primary and secondary home audiovisual networks 37 and 38 (namely the nodes and their interconnection by the IEEE 1355 type links) implement one and the same proprietary transmission protocol.

In the example of FIG. 1, the primary home audiovisual network comprises:

a source node 3 including a satellite television receiver whose antenna is referenced 4. This source node 3 is connected to the node referenced 7 and to the gateway 32, through IEEE 1355 type links. Purely with a view to simplification, no analog terminal is connected to its analog interface and no IEEE 1394 type bus is connected to its corresponding interface;

a node referenced 7 connected to the nodes referenced 3, and 39a through IEEE 1355 type links. A television set 303 is connected to its analog interface. An IEEE 1394 type bus is connected to its corresponding interface and a terminal is connected to this bus, namely a camcorder (registered mark) 8 through an analog/digital converter 304. It is clear that if the camcorder 8 has a digital output, it can be connected directly to the IEEE 1394 bus;

a node referenced 39a, connected to the nodes referenced 7, through IEEE 1355 type links. A television set 301 is connected to its analog interface;

a gateway 32 connected, firstly, to the source node 3, through an IEEE 1355 type link and, secondly, to the communications network 34, through an interface adapted to the nature of the network referenced 34. A communications network 34 of this kind is, for example, a telephony network.

In the example of FIG. 1, the secondary home audiovisual network 38 comprises:

a gateway 33 connected, firstly, to the communications network 34, through an interface adapted to the nature of this network referenced 34 and, secondly, to the source nodes referenced 5 and 39b, through IEEE 1355 type links.

a node referenced 5, connected to the gateway 33, through IEEE 1355 type links. A television set 6 is connected to its analog interface. An IEEE 1394 type bus is connected to its corresponding interface and a video tape recorder 30 is connected to this bus through an analog/digital converter 31.

a node referenced 39b, connected to the gateway 33, through IEEE 1355 type links. A television set 301 is connected to its analog interface;

By way of an illustrative example, the following two cases are considered hereinafter in the description:

first case: the user wishes to receive a satellite television program on the television set 6 connected to the node 5 of the secondary home audiovisual network 38, this satellite television program being received by the source node 3 (“talker”) of the primary home audiovisual network 38. In this first case, the television set 6 is a destination terminal (“listener”) and the node referenced 5 is a destination node);

second case: the user wishes to receive, on the television set 6, connected to the node 5 of the secondary home audiovisual network, audiovisual signals generated by the camcorder 8 connected to the node referenced 7 of the secondary home audiovisual network. Just as in the first case, the television set 6 is a destination terminal (“listener”) and the node referenced 5 is a destination node. Furthermore, the camcorder 8 is an input terminal (“talker”) and the node referenced 7 is an input node.

FIG. 15 illustrates the structure of a primary or secondary network gateway in a preferred embodiment of the invention. With a view to simplifying the description, it is assumed that the gateway illustrated in FIG. 15 is a gateway of a secondary home audiovisual network.

The gateway 33 of FIG. 15 can be subdivided into two distinct parts:

a first set of elements (not referenced in FIG. 15) sees to the processing of the signals received, through the communications network 34, from the gateway 32 of the secondary home audiovisual network;

a second set of elements 35 is designed to ensure the functionalities of the gateway within the switched audiovisual network to which it belongs.

The first set of elements comprises:

a central processing unit (CPU) 13c;

a ROM (read-only memory) type permanent storage means 14c that stores the algorithms proper to the invention described here below with reference to the FIGS. 16 and 17 (it will be noted that the ROM of the primary gateway 32 stores the algorithm proper to the invention, described here below with reference to FIG. 18);

a RAM (random access memory) type of temporary storage means 15c;

a module 36 for the management of the access to the communications network 34. It is through this module 36 that the secondary gateway 33 receives the data sent by the primary gateway 32 through the communications network 34. A module 36 of this kind provides especially for the management of keys exchanged between the gateways 32 and 33 during a phase of mutual identification prior to the establishment of a connection between a destination terminal of the secondary network and a source node of the primary network;

a conditional access device 16c storing the key specific to the gateway 33 mentioned here above.

The second set of elements 35 of the gateway combines characteristic functional elements of the technology implemented in the primary and secondary switched audiovisual network of the invention, and has at least two external input/output ports respectively connected to a serial communications bus designed to function according to the IEEE 1394 standard, and to a switched network according to the IEEE 1355 standard.

The set 35 comprises especially:

a block 18c for the conveyance of CIP (common isochronous packet) type packets according to the IEC 61883 standard. A block 18c of this kind is supplied with data coming from the demultiplexer 11 and from the access management module 12 and delivers CIP type packets after having time-stamped them;

a module 19c that provides the interface with the central processing unit for the elements referenced 18c, 20c and 21c;

a transportation module 20a made for example according to the FPGA technology;

a device 21a known as a “1394 bridge” providing the interface, within the source node, between, firstly, the switched audiovisual network of the invention consisting of IEEE 1355 links and, secondly, a serial communications bus, designed to work according to the IEEE 1394 standard, to which the gateway 33 is attached;

a switching module 22c having three input/output ports connected to the secondary switched audiovisual network of the invention consisting of IEEE 1355 links through which it is possible especially to connect the gateway 33 to a destination node of the secondary home audiovisual network;

an interfacing means 23c comprising a set of PHY/LINK 1394 components. The interfacing means 23c comprise at least one external port designed to be connected to a terminal (data-processing device or peripheral), through a 1394 serial communications bus.

The gateway may furthermore comprise means (not shown in FIG. 15) for the compression/decompression and/or the encryption/decryption of the audiovisual signals.

Referring to FIGS. 16 to 17, we shall now provide a description in greater detail of the working of the gateway of FIG. 10 during the steps of initialization and transmission of an audiovisual signal of the method of the present invention.

FIGS. 16 and 17 describe the working of the gateway 33 of a secondary home audiovisual network 38 while FIG. 18 illustrates the working of the gateway 32 of a primary home audiovisual network 37.

The algorithms described with reference to FIGS. 16 and 17 are stored in the ROM of the secondary gateway. When the power is turned on, they are loaded into the RAM and the central processing unit (CPU) will execute the instructions corresponding to this algorithm.

More specifically, FIG. 16 describes the working of the secondary gateway 33 during the step of initialization of the connection between the primary network 37 and the secondary network 138.

An initialization of this kind is activated by a step 110 of requesting information on the availability of the primary network 37 by the gateway of the secondary network 33. For example, a request of this kind is implemented when a user gets connected by means of an infrared remote control 9 to the destination node referenced 5 of the secondary network 38, and thus performs an IR_SCAN type operation.

A request 110 of this kind activates a step of mutual identification of the gateway is referenced 32 and 33 comprises the following sub steps:

during a step referenced 111, the gateway service is activated and the gateways referenced 32 and 33 undertake a temporarily connection phase. Depending on the type of communications network 34, the communications protocol of the network 34 may or may not request the allocation of specific resources to this network 34 (referred to as “management of the resources of the network” in FIG. 16);

during a step referenced 112, it is verified that the connection between the gateways referenced 32 and 33 has been made properly:

if the answer is negative, the connection is not validated (113), for example because of a problem that has occurred in the communications network 34 or a malfunction in the primary gateway 32;

if on the contrary the answer is yes, if the connection has been properly made, the secondary link 33 sends (114) an access key to the resources of the primary network 37 to the primary gateway 32, through the communications network 34.

the key is verified within the primary network 37, for example by the comparison with a key stored in the primary gateway 32.

the secondary gateway 33 receives a response (15) from the primary network 37:

if the key of the secondary gateway 33 is not authenticated by the primary network 37, the connection of the primary and secondary gateways is not validated (16), and the secondary gateway 33 is refused access to the primary network 37;

in the event of a positive verification of the key, on the contrary, the communication of the secondary gateway 33 with the primary network 37 is set up (117).

The primary gateway 32 and the secondary gateway 33 may then exchange control and configuration messages. In particular, a destination node of the secondary network 38 may receive information on the availability of the primary network 37 in an absolutely transparent way for a user of this node, who cannot distinguish whether this information comes from the audiovisual network in which he is located or a remote audiovisual network. Information of this kind enables a user of the secondary network 38 to know which are the source nodes of the primary network to which he can gets connected.

It is also possible to envisage a situation where such information pertains to the nodes and to the active destination terminals of the primary network 37 (for example a user of the secondary network 38 may have knowledge of television sets or DVD readers commonly used in the primary network 37).

This information may be transmitted by the primary gateway 32 in the form of packets comprising:

a header indicating that the packet conveys the result of the verification of the key sent by the secondary gateway 33;

a field indicating the result of the verification of the key, and conveying the information on the availability of the primary network.

At the end of the initialization step illustrated in FIG. 16, a user of the secondary network 38 may decide that he wishes to set up a permanent connection between the primary gateway 32 and the secondary gateway 33, so that, for example, on the television set 6 of the secondary network 38, he can view a program received via a satellite television receiver of the source node 3 of the primary network 37.

A permanent connection step of this kind is illustrated, on the secondary gateway 33 side, in FIG. 17. It will be noted that the working of the secondary gateway 33 during the permanent connection step is similar to its working during the initialization step of FIG. 16, except that:

the first step referenced 120 is a step requesting connection to the primary network which, for example, may be implemented by a user of the secondary network 38, by pressing the connection key of the infrared remote control 9 cooperating with the destination node 5 of the secondary network 38;

during the communications step referenced 127, between the primary network 37 and the secondary network 38, audiovisual signals in the form of packets are transmitted, in addition to configuration and control information exchanged during the communications phase referenced 117 of FIG. 16.

The steps illustrated in FIG. 17 shall therefore not be described in greater detail.

FIG. 18 shows a view corresponding to that of FIG. 17 on the gateway 32 side of the primary network 37.

The algorithm described with reference to FIG. 18 is stored in the ROM of the destination node. When the power is turned on, this algorithm is loaded into the RAM and the central processing unit (CPU) will execute the instructions corresponding to this algorithm.

During a step referenced 130, the primary gateway 32 receives an external connection request through the output port which connects it to the communications network 34. There follows a step referenced 111, already described here above, for the activation of the gateways service, during which a phase for the connection of the primary gateway 32 and the secondary gateway 33 is implemented.

The success of the connection is then ascertained (112). In the event of failure (113), the connection is not validated. In the event of success, the primary gateway 32 awaits (134) a key coming from the secondary gateway 33.

To this end, it can be planned that the primary gateway 32 will send a message to the secondary gateway 33 comprising:

a header indicating that the packet is conveying a key request instruction;

a field describing the nature of the required key.

The primary gateway 32 then verifies (135) the validity of this key. In the event of a negative result for the verification, the connection is not validated (116) and the primary gateway 32 rejects access by the secondary gateway 33 to the primary network 37.

In the event of a positive result for the verification, communication is set up (137) between the primary network 37 and the secondary network 38, and the primary gateway 32 may transfer control and configurations messages and audiovisual signals in the form of packets to the secondary link with 33 in order to introduce them into the secondary network 38.

What is claimed is: Transmission Method Claims from CRF-464 (7093)

1. A method for the transmission of audiovisual signals between at least one source node and at least one destination node of a home audiovisual network,
wherein said source node or nodes insert a piece of information, into said audiovisual signals, to control the copying and/or broadcasting of said audiovisual signals by said destination node or nodes,
and wherein said home audiovisual network is a switched type network.

2. A method according to claim 1, wherein said piece of control information comprises a first information element specifying whether a destination node permits or does not authorize at least one destination terminal, connected to said destination node, to copy said audiovisual signal on a data carrier.

3. A method according to claim 2, wherein said first information element is encoded on one bit.

4. A method according to any of the claims 2 and 3, wherein said first information element, depending on its value, activates or deactivates anti-copy means contained in the corresponding destination node, acting on said audiovisual signal so as to enable it to be viewed but not recorded.

5. A method according to claim 4, wherein said anti-copy means introduce a scrambling operation according to the “Macrovision” standard.

6. A method according to any of the claims 1 to 5, wherein said control information comprises a second information element specifying whether the corresponding audiovisual signal is intended for a particular destination terminal, connected to a destination node, and/or for a particular user or whether it can be transmitted to any destination terminal connected to a destination node.

7. A method according to claim 6, wherein said second information element is encoded on one bit.

8. A method according to any of the claims 6 and 7 wherein, when said second information element specifies that the audiovisual signal is intended for a particular destination terminal, connected to a destination node, and/or for a particular user, the destination node implements a corresponding control mechanism

9. A method according to claim 8, wherein said control mechanism comprises a step for the detection of a local key, known to said destination node and/or introduced by said user.

10. A method according to claims 2 and 6, wherein said control information comprises said first information element and said second information element.

11. A method according to any of the claims 1 to 10, wherein said audiovisual signals, called first audiovisual signals, transmitted by said source node to a destination node, are in digital form according to a first encoding format,
wherein said first audiovisual signals undergo a decoding, in said destination node, corresponding to said first encoding format and are then transmitted to a destination terminal connected to said destination node:
in said decoded digital form if said destination terminal is digital
or, after digital/analog conversion, in analog form if said destination terminal is an analog device
and wherein said source node assigns an inactive value to said control information when said destination terminal is digital.

12. A method according to claim 11, comprising a preliminary step of connection between said destination node and the source node, during which said destination node gives said source node a piece of information on nature, namely the analog or digital nature, of said destination terminal.

13. A method according to any of the claims 11 and 12, wherein at least certain of said first audiovisual signals furthermore undergo a DTCP type encoding in the source node, corresponding decoding means being provided in the destination terminal, connected to said destination node.

14. A method according to any of the claims 1 to 13, wherein said audiovisual signals, called first audiovisual signals, transmitted by said source node to a destination node are in digital form according to a first encoding format,
wherein second audiovisual signals can be transmitted from an input terminal to an input node (a notion distinct from that of the source node) to which said input terminal is connected in digital form according to a second encoding format, distinct from said first encoding format
and wherein, when a destination node receives said second audiovisual signals from said input node, said destination node does not take account of said control information.

15. A method according to any of the claims 11 to 14, wherein said first encoding format is an MPEG format.

16. A method according to any of the claims 14 and 15, wherein said second encoding format is a DV format.

17. A method according to any of the claims 1 to 16 wherein, when said destination node has to take account of said control information and when this information prohibits copying, said destination node systematically closes the accesses to the digital output(s) that it possesses.

18. A method according to any of the claims 1 to 17, wherein said audiovisual signals are conveyed between a source node and a destination node in successive packets, each comprising a header and a data field.

19. A method according to claim 18, wherein said control information is transmitted in a particular field, designed for this purpose, of said header, in at least certain of said packets.

20. A method according to claim 19, wherein said control information is present in all the packets.
Added Method Claims from CRF-465 (7094)

21. A method according to any of the claims 1 to 20, wherein said method implements a token-based mechanism for the transmission of the audiovisual signals,
wherein, prior to said transmission of said audiovisual signal, said method comprises a step for assigning an available conditional access token to a connection enabling said transmission between the source node and the destination node, said conditional access token authorizing:
the transmission of said audiovisual signal to the destination node,
the processing of said audiovisual signal by the destination node only if the destination node fulfills a predetermined condition,
and wherein said piece of information, inserted in said audiovisual signal by the source node or nodes to control the copying and/or broadcasting, specifies said determined condition.

22. A method according to claim 21, wherein said tokens are managed by said at least one source node.

23. A method according to any one of the claims 21 and 22, wherein at least certain of said tokens are generic tokens enabling access to any one of the channels of the set of channels received by said source node.

24. A method according to any one of the claims 21 to 23, wherein at least certain of said tokens are dedicated tokens enabling access to predetermined audiovisual signals.

25. A method according to claim 24, wherein these predetermined audiovisual signals may belong especially to the group comprising:
audiovisual signals relating to a predetermined channel of a set of channels received by said source node;
audiovisual signals relating to a predetermined program of a channel among a set of channels received by said source node;
audiovisual signals relating to a predetermined family of programs.

26. A method according to claim 25, wherein said predetermined family of programs groups together at least two programs as a function of a criterion belonging to the group comprising:
the type of said programs;
the contents of said programs;
the time of broadcast of said programs on a channel.

27. A method according to any one of the claims 21 to 26, wherein at least certain of said tokens are dated, timed and/or have a predetermined lifetime.
Added Method Claims from CRF-466 (7095)

28. A method according to any one of the claims 1 to 27, wherein said at least one source node is comprised in a primary home audiovisual network, and comprises reception means for the reception of a source signal and transmission means for the transmission of said source signal in the form of an audiovisual signal in which is inserted said piece of information to control the copying and/or broadcasting,
wherein said at least one destination node is comprised in a secondary home audiovisual network in a remote site, and does not comprise reception means for the reception of said source signal,
and wherein said primary and secondary networks are each equipped with a gateway enabling their transparent interconnection, through a communications network, so that said source signal received by said source node of said primary network can be transmitted in the form of said audiovisual signal, to said destination node of the secondary network.

29. A method according to claim 28, wherein said primary and secondary networks are switched type networks.

30. A method according to either of the claims 28 and 29, wherein said primary and secondary networks implement one and the same proprietary transmission protocol.

31. A method according to any of the claims 28 to 30, wherein said interconnection between said gateways includes a mutual identification step.

32. A method according to any of the claims 28 to 31, comprising an initialization step and a step for transmitting an audiovisual signal.

33. A method according to claim 32, wherein a connection is set up for each of said steps and interrupted at the end of each of said steps.

34. A method according to any of the claims 32 and 33, wherein said initialization step includes a sub-step for the transmission of information on the availability of said primary network.

35. A method according to claim 34, wherein said information on the availability of said primary network comprises:
information on the source node or nodes of these primary networks;
information on the input node or nodes of the primary network;
information on the destination node or nodes of the primary network;
information on the destination terminal or terminals of the primary network;
information on the input terminal or terminals of the primary network.

36. A method according to any of the claims 28 to 35, wherein said communications network belongs to the group comprising:
Internet type networks;
telephony type networks;
radiotelephony type networks;
television broadcast networks.

37. A method according to any of the claims 28 to 36, wherein said gateways comprise means of compression/decompression and/or encryption/decryption.
(Source Side) Device Claim from CRF-464 (7093)

38. A device included in a home audiovisual network, which is a switched type network, interconnecting at least one source node and at least one destination node, said device comprising means for the insertion, into an audiovisual signal to be sent from a source node to a source destination, of a piece of information to control the copying and/or broadcasting of said audiovisual signal by said destination node.
(Source Side) Device Claim from CRF-465 (7094)

39. A device according to claim 38, comprising means for the management of a set of tokens, an audiovisual signal being incapable of being transmitted from a source node to a destination node unless a corresponding token is available.
Source Node Claim from CRF-464 (7093)

40. A source node of a home audiovisual network interconnecting at least one source node and at least one destination node, comprising a device according to any of claims 38 and 39.
(Destination Side) Device Claims from CRF-464 (7093)

41. A device included in a home audiovisual network, which is a switched type network, interconnecting at least one source node and at least one destination node, said device comprising means for the analysis of a piece of information to control the copying and/or broadcasting of an audiovisual signal by a destination terminal, said control information being inserted into an audiovisual signal sent by a source node.

42. A device according to claim 41, comprising anti-copy means acting on said audiovisual signal so as to enable its viewing but not its recording, said anti-copy means being controlled by said analysis means.
Destination Node Claim from CRF-464 (7093)

43. A destination node of a home audiovisual network interconnecting at least one source node and at least one destination node, comprising a device according to claim 41 or 42.
Control Method Claims from CRF-464 (7093)

44. A method for the control, by a remote operator, of an authorization of copying and/or broadcasting, in a home audiovisual network, of audiovisual signals given by said remote operator, wherein said home audiovisual network is a switched type network, and wherein said operator transmits, to a source node of said audiovisual network, designed to transmit said audiovisual signals to at least one destination node, a piece of information to control the copying and/or the broadcasting of said audiovisual signals by said destination node or nodes, said control information being designed to be inserted by said source node into said audiovisual signals.
Control Method Claims from CRF-465 (7094)

45. A method for the control, by a remote operator, of an authorization of transmission of an audiovisual signal, given by said remote operator of a source node to a destination node of a home audiovisual network,
wherein said remote operator transmits information on a token-based mechanism to said source node as a function of requests from the user and/or promotional operations,
said audiovisual signal being incapable of being transmitted to said destination node unless a corresponding token is available.
Gateway Claims from CRF-466 (7095)

46. A gateway of a primary home audiovisual network comprising at least one source node,
comprising means of interconnection to a gateway of a secondary home audiovisual network comprising at least one destination node
so that a source signal received by a source node of said primary network can be transmitted in the form of an audiovisual signal, to a destination node of the secondary network, without there being means included in this secondary network for the reception of said source signal.

47. A gateway of a secondary home audiovisual network comprising at least one destination node,
comprising means of interconnection to a gateway of a primary home audiovisual network comprising at least one source node,
so that a source signal received by a source node of said primary network can be transmitted, in the form of an audiovisual signal, to a destination node of the secondary network, without there being means included in this secondary network for the reception of said source signal.
Allocation Method Claim from CRF-466 (7095)

48. A method for the allocation by an operator of transmission resources on a communication network.
wherein the conditions of allocation of said resources for a link between a gateway of a primary home audiovisual network and a gateway of a secondary home audiovisual network depend on access rights pertaining to a source node of said primary network allocated by a third-party operator.
Computer Program and Computer Program Product Claims from CRF-464 (7093)

49. A computer program comprising instruction sequences adapted to the implementation of a method of the kind mentioned here above, when said program is executed on a computer.

50. A computer program product, adapted to the transmission of audiovisual signals between at least one source node and at least one destination node of a home audiovisual network which is a switched type network,
said computer program product comprising program code instructions recorded in a medium that can be used in a computer, comprising:
programming means readable by computer to carry out a phase for the insertion inside said audiovisual signals, by said source node or nodes, of a piece of information to control the copying and/or the broadcasting of said audiovisual signals by said destination node or nodes.
Added Control Method Claims from Search Report Analysis of CRF-464 (7093)

51. A method for controlling the transfer of multimedia data within a multimedia network comprising at least a source node and a destination node, at least the destination node being connected to different types of terminals, information regarding the access and/or the copy of said multimedia data being included into said multimedia data,
characterized in that the processing of the information regarding the access and/or the copy of the multimedia data is made according to the type of the destination terminal.

52. A method according to claim 51, wherein the type of the destination terminal is analog or digital terminal.
Independent Claim=Method Claim 1 of CRF-465 (7094)

53. A method for the transmission of audiovisual signals between at least one source node and at least one destination node of a home audiovisual network,
wherein said method implements a token-based mechanism for the transmission of an audiovisual signal,
an audiovisual signal of this kind being incapable of being transmitted to a destination node unless a corresponding token is available.
Independent Claim=Method Claim 1 of CRF-466 (7095)

54. A method for the remote use of means for the reception of source signals belonging to a primary home audiovisual network comprising at least one source node,
wherein there is implemented, in a remote site, a secondary home audiovisual network comprising at least one destination node,
said primary and secondary networks being each equipped with a gateway enabling their transparent interconnection, through a communications network, so that a source signal received by a source node of said primary network can be transmitted in the form of an audiovisual signal, to a destination node of the secondary network, without the latter having reception means for the reception of said source signal.
